(19) United States
(12) Patent Application Publication
(10) Pub. No.: US 2026/0169309 A1
(43) Pub. Date: Jun. 18, 2026

(54) DYNAMICALLY FOCUSABLE LENS

(71) Applicant: CYBORG INDUSTRIES, LLC, Austin, TX (US)

(72) Inventor: Keenan Valenine, Autin, TX (US)

(21) Appl. No.: 19/125,167

(22) PCT Filed: Oct. 28, 2023
(86) PCT No.: PCT/US2023/036213

§ 371 Date: Apr. 28, 2025

Related U.S. Application Data
(60) Provisional application No. 63/381,531, filed on Oct. 28, 2022.

(51) Int. Cl. G02C 7/08; G02C 7/06; G02C 11/00

(52) U.S. Cl. CPC G02C 7/085; G02C 7/063; G02C 11/10; G02C 2202/24

(57) ABSTRACT

A system, method for creating a dynamically focusable optical device, and a device to correct human ametropic vision are disclosed. The system, method for creating the optical device, and device comprise one or more dynamically focusable zones within one or more lenses, one or more optical working fluids, one or more electromagnetic or manual actuators, with the one or more electromagnetic actuators connected to a microcontroller electrically powered by one or more battery(ies). All components of the optical device that are worn over the face are housed in an eyewear frame.

### FIELD OF INVENTION

The present invention is directed to dynamically focusable optical devices for correcting human ametropic vision, and more specifically provides a system, method for creating an optical device, and a device to correct human ametropic vision.

### BACKGROUND

Externally-worn optical devices that correct human ametropic vision are mostly static focus lenses, e.g., single vision, bifocal, trifocal, or progressive lenses. When more than one optical power is needed, a static lens produces each optical power on a different partition of the lens and thereby relegating the in-focus light to that small partition of the lens. This lens partitioning reduces the in-focus field of view and causes functional inconvenience and hazard, such as the lens wearer needing to tilt head up/down, left/right to find the partition of the static lens that correctly focuses the object and with the location of the partition being far from best. In contrast, a dynamically focusable lens enables a partition of a lens to dynamically change its optical power to suit the multiple optical needs of the wearer, such as both distance vision and near vision in a single lens partition.

Moreover, existing dynamically focusable lenses that use one or more optical fluids to change the geometry of the lens (and thereby creating the dynamically focusable lenses) use too much and/or too many fluids, which makes the fluidic lens overly thick and heavy. Moreover, the one or more optical fluids are not refractive index-matched to the balance of lens components and thereby make the lens components visible. Such visibility reduces optical quality and is also aesthetically unsightly.

Therefore, a need exists for better quality solutions to these and related issues.

### SUMMARY

A system and method for creating a dynamically focusable optical device, and a device to correct human ametropic vision are disclosed. The system and method for creating the optical device, and device comprise one or more of: (1) at least one lens having one or more smaller dynamically focusable zones that is connected to at least one cavity internal to the at least one lens, one or more refractive index-matched optical working fluids filling the one or more dynamically focusable zones and the at least one cavity in the at least one lens, the at least one lens having a flexible film bonded to a solid optical layer with such solid optical layer having at least one void (i.e., cavity), the one or more optical working fluids within the at least one lens contacting both the solid optical layer and the flexible film by filling the at least one void, and/or (2) one or more electromechanical or manual actuators capable of moving at least a portion of the one or more optical working fluids into and out of the one or more lenses creating one or more dynamic optical powers in the one or more dynamically focusable zones.

This application provides a system and method for creating the optical device wherein the device(s) comprise one or more electromechanical actuators wherein the system and method for creating the optical device comprise one or more of: (1) the one or more electromechanical actuators connected to one or more electronic controllers commanding (i.e., instructing) the at least one or more electromechanical actuators, the one or more battery (ies) powering at least one or more of the one or more electronic controllers and the one or more electromechanical actuators, and a frame housing all components of the optical device for wear over the face and ears of a user, and/or (2) one or more actuation command sensors capable of receiving user command(s) to operate the one or more electromechanical actuators, and capable of communicating such command(s) (i.e., operative instruction(s)) to the one or more electronic controllers.

It will also be understood that “has”, “have” or “having” as used herein, mean “comprising”, “comprise” or “comprised of”. In this invention, the phrases “at least one of” and “one or more of” have equivalent meaning, are used interchangeably, and should be interpreted in the disjunctive. That is one or more of the listed criterion is required.

### BRIEF DESCRIPTION OF THE DRAWINGS

A more detailed understanding may be had from the following description, given by way of example in conjunction with the accompanying drawings and tables wherein:

FIG. 1A shows a front-facing dynamically focusable lens comprising a circular dynamically focusable zone located towards the bottom and inner corner (towards nose) of the dynamically focusable lens and an irregularly shaped fixed focus zone.

FIG. 1B shows a front-facing dynamically focusable lens comprising an oval dynamically focusable zone located towards the bottom and inner corner (towards nose) of the dynamically focusable lens and an irregularly shaped fixed focus zone.

FIG. 1C shows a front-facing dynamically focusable lens comprising an irregularly shaped dynamically focusable zone located towards the bottom and inner corner (towards nose) of the dynamically focusable lens and an irregularly shaped fixed focus zone.

FIG. 2A shows a front-facing dynamically focusable lens with two dynamically focusable zones positioned outside of and around a circular fixed focus zone.

FIG. 2B shows a front-facing dynamically focusable lens with one dynamically focusable zone positioned outside of and around an oval fixed focus zone.

FIG. 2C shows a front-facing dynamically focusable lens with four dynamically focusable zones positioned outside of and around a circular fixed focus zone.

FIG. 2D shows a front-facing dynamically focusable lens with multiple dynamically focusable zones positioned outside of and around an irregularly shaped fixed focus zone.

FIG. 3A shows one example front-facing dynamically focusable lens and 3 lines each indicating a cross-sectional construction of the lens at location. FIG. 3A further shows one dynamically focusable zone and one fixed focus zone for the purpose of correcting ametropia.

FIG. 3B shows a front-facing dynamically focusable lens with two dynamically focusable zones and one fixed focus zone for the purpose of controlling myopia.

FIG. 3C shows an example construction of a dynamically focusable lens at a cross-section of the lens' border (i.e., perimeter).

FIG. 3D shows an example construction of a dynamically focusable lens at a cross-section of the lens' fixed focus zone and border.

FIG. 3E shows an example construction of a dynamically focusable lens at a cross-section of the lens' dynamically focusable zone, fixed focus zone and border.

FIG. 4A illustrates a cross-section of a dynamically focusable lens comprising a dynamically focusable zone, a fixed focus zone and lens border. FIG. 4A schematically illustrate that the optical power in a dynamically focusable zone can be changed by commensurately changing the geometry of a flexible optical power layer.

FIG. 4B is an enlarged illustration of an exemplary cross-section of a dynamically focusable zone, with various states of flexure of a flexible optical power layer. FIG. 4B schematically illustrate that the optical power in a dynamically focusable zone can be changed by commensurately changing the geometry of a flexible optical power layer.

FIG. 5A illustrates a uniform add power having a d-Rx of 1.5 OD in the optical area of a dynamically focusable zone.

FIG. 5B illustrates a higher uniform add power having a d-Rx of 3.0 OD in the optical area of the same dynamically focusable zone by the internal optical working fluid having a higher internal pressure.

FIG. 5C illustrates a dynamically focusable zone producing bifocal add powers having d-Rx(s) of 1.0 OD and 2.0 OD, with a bifocal separation line (or curve) within the optical area of the zone.

FIG. 5D illustrates a dynamically focusable zone producing progressive add powers having d-Rx(s) smoothly ranging from 1.0 OD to 3.0 OD, without having multifocal separation lines (or curves) in the optical area of the dynamically focusable zone.

FIG. 6 illustrates core components of an electromechanical Integrated Eyewear on one side. Specifically, a dynamically focusable lens, having a dynamically focusable zone, is connected to a frame temple and to a reservoir, with the temple comprising a reservoir, an electromechanical actuator, a circuit board having an electronic controller, an actuation command sensor (e.g., a tap/swipe sensor), a battery and their connections.

FIG. 7 illustrates core components of a manual mechanical Integrated Eyewear on one side. Specifically, a dynamically focusable lens, having a dynamically focusable zone, is connected to a frame temple and to a reservoir, with the temple comprising a reservoir, a manual mechanical actuator and their connection(s).

FIG. 8A illustrates an example construction of a dynamically focusable lens, viewed at a cross-section comprising a dynamically focusable zone, with an adhesive layer fully covering a flexible optical power layer and the adhesive layer being directly exposed to an optical working fluid.

FIG. 8B illustrates an example construction of a dynamically focusable lens, viewed at a cross-section comprising a dynamically focusable zone, with an adhesive layer partially covering a flexible optical power layer and the flexible optical power layer being directly exposed to an optical working fluid.

FIG. 9A illustrates an embodiment of fluidic connections between a DFZ, an NOC, an opening in a DFL and a reservoir.

FIG. 9B illustrates an embodiment of fluidic connections between a DFZ, an SCTD, an opening in a DFL and a reservoir.

FIG. 10 illustrates a transmission spectrum of an embodiment of a Blue Cut DFL.

FIG. 11A illustrates a transmission spectrum of an embodiment of a Color Enhancing DFL.

FIG. 11B illustrates a transmission spectrum of an embodiment of a Color Enhancing DFL that controls color inconstancy and also illustrates a corresponding reference transmission spectrum that does not control color inconstancy.

### DETAILED DESCRIPTION

In the following description, numerous specific details are set forth, such as particular structures, components, materials, dimensions, processing steps, and techniques, in order to provide a thorough understanding of the present embodiments. However, it will be appreciated by one of ordinary skill of the art that the embodiments may be practiced without these specific details. In other instances, well-known structures or processing steps have not been described in detail in order to avoid obscuring the embodiments. It will be understood that when an element such as a layer, region, or substrate is referred to as being “on” or “over” another element, it can be directly on the other element or intervening elements may also be present. In contrast, when an element is referred to as being “directly on” or “directly” over another element, there are no intervening elements present. It will also be understood that when an element is referred to as being “beneath,” “below,” or “under” another element, it can be directly beneath or under the other element, or intervening elements may be present. In contrast, when an element is referred to as being “directly beneath” or “directly under” another element, there are no intervening elements present. It will also be understood that “has”, “have” or “having” as used herein, mean “comprising”, “comprise” or “comprised of”. In this invention, the phrases “at least one of”, “at least one”, “one or more of” and “one or more” have equivalent meaning, are used interchangeably, and should be interpreted in the disjunctive. That is one or more of the listed criterion is required. Furthermore, when the phrases “at least one of”, “at least one”, “one or more of” or “one or more” is followed by and paired with “and”, the “and” should be interpreted should be interpreted in the disjunctive as in “and/or”—that is one or more of the listed criterion is required.

In the interest of not obscuring the presentation of embodiments in the following detailed description, some structures, components, materials, dimensions, processing steps, and techniques that are known in the art may have been combined together for presentation and for illustration purposes and in some instances may have not been described in detail. In other instances, some structures, components, materials, dimensions, processing steps and techniques that are known in the art may not be described at all. It should be understood that the following description is rather focused on the distinctive features or elements of various embodiments described herein.

The described systems and methods provide the designs and constructions of devices with one or more desired dynamically focusable lens (“DFL”), which is integrated with an eyewear frame that houses one or more subsystems in order to form an integrated eyewear (“Integrated Eyewear”) for human use. The Integrated Eyewear is worn externally over the eyes.

The words “dynamic focus” and “dynamically focusable” have equivalent meaning and can be used interchangeably.

There is at least one DFL, preferably two DFLs, in an Integrated Eyewear. The dynamic focus of the lens is achieved by controllable changes in the geometry, i.e., shape, of at least one component of the DFL, which controllably changes the refraction, e.g., magnification, of the dynamically focusable zone(s) (“DFZ(s)”) of the DFL.

A DFL has at least one DFZ. An Integrated Eyewear has at least one DFZ. Preferably, an Integrated Eyewear has at least two DFZs, one for each eye.

For every geometry profile (i.e. shape) of at least one component of a DFL, which controls refraction in a DFZ, a DFZ may have a singular focal length for an entire DFZ or multiple different focal lengths for a DFZ. Moreover, as the geometry profile of at least one component of the DFL dynamically changes, the focal length(s) of a DFZ also dynamically changes in a controlled manner, which is one of the main optical functions of this invention. Dynamic change (or dynamically changeable) means the focal length(s) of a DFZ can (or have the capability to) controllably change in time. Such dynamic change is at least one of (1) electrically, mechanically and/or electromechanically controlled by the wearer of the Integrated Eyewear, and (2) electromechanically controlled by one or more electromechanical subsystems of the Integrated Eyewear.

In a DFL, any optical area outside of the DFZ have one or more fixed, i.e., not dynamically changeable, focal lengths. Such optical area is called Fixed Focus (plural Foci) Zone (“FFZ”).

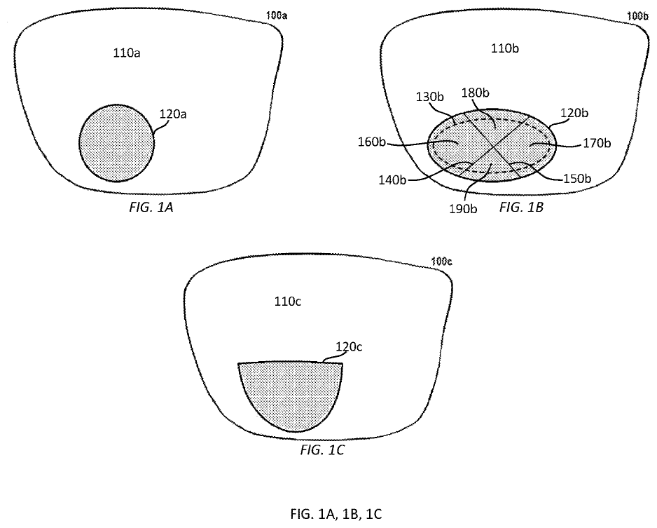

As examples, FIG. 1 shows of three regularly and irregularly shaped DFZs and three irregularly shaped FFZs, in three DFLs, in a frontal view. FIG. 1A illustrates a circular DFZ 120a, an irregularly shaped FFZ 110a, in a DFL 100a. FIG. 1B illustrates an oval DFZ 120b, an irregularly shaped FFZ 110b, in a DFL 100b. FIG. 1C illustrates an irregularly shaped DFZ 120c, an irregularly shaped FFZ 110c, in a DFL 100c. These are examples, while a DFZ may have any regular or irregular shape.

In one embodiment, an Integrated Eyewear with two DFZs, with one DFZ for each eye, can assist the vision of people with refractive error (“ametropia”), e.g., presbyopia, myopia, hyperopia, and astigmatism, by looking through at least one DFZ, preferably both DFZs, at objects which are at one or more of near, far, and intermediate distances.

In another embodiment of a DFL that corrects ametropia, a DFZ is positioned towards at least one of the lower side and inner side of a DFL. Inner side is the side of a DFL that is closest to the nose of the wearer of the Integrated Eyewear.

In one embodiment, the optical center of a DFL used for distance vision, i.e., far distance vision, is outside of the optical area of a DFZ. Furthermore, the optical center of a DFL used for near vision, i.e., near distance vision, is positioned inside of the optical area of a DFZ, and preferably positioned at an optical center of a DFZ.

In one embodiment of a DFL that corrects ametropia, at least one optical area used for intermediate vision, i.e., intermediate distance vision, is positioned inside of the optical area of a DFZ (“Dynamic Intermediate Vision”).

In another embodiment of a DFL that corrects ametropia, at least one optical area used for intermediate vision is positioned outside of the optical area of a DFZ (“Fixed Intermediate Vision”).

The near point of a person's vision is defined at 34 centimeters (“cm”) away from the nasion of a wearer's head. The far point of a person's vision is defined at 6 meters (“m”) away from the nasion. Near vision of a person is to see objects at the near point or nearer. Distance vision is to see objects at the far point or farther. Intermediate vision is to see objects at any distance in between the near point and far point.

In one embodiment of a DFL that corrects ametropia, the at least one of optical center and geometric center of a DFZ is positioned at an optical center (for distance vision) of a DFL, when viewed from the front.

In another embodiment of a DFL that corrects ametropia, the at least one of optical center and geometric center of a DFZ is positioned at a geometric center of a DFL.

In yet another embodiment of a DFL that corrects ametropia, the at least one of optical center and geometric center of a DFZ is positioned away from at least one of an optical center (for distance vision) and a geometric center of a DFL. Preferably, the at least one of optical center and geometric center of a DFZ is positioned away from both an optical center (for distance vision) and a geometric center of a DFL.

In one embodiment of a DFL that corrects ametropia, the area (i.e., optical area) of a DFZ is at least 80 square millimeters (“mm”), preferably at least 150 square mm, more preferably at least 175 square mm, even more preferably at least 200 square mm, yet more preferably at least 250 square mm, and furthermore preferably at least 300 square mm.

In another embodiment of a DFL that corrects ametropia, the optical area of a DFZ is less than 900 square mm, preferably less than 750 square mm, more preferably less than 650 square mm, even more preferably less than 550 square mm, yet more preferably less than 450 square mm, and furthermore preferably less than 350 square mm.

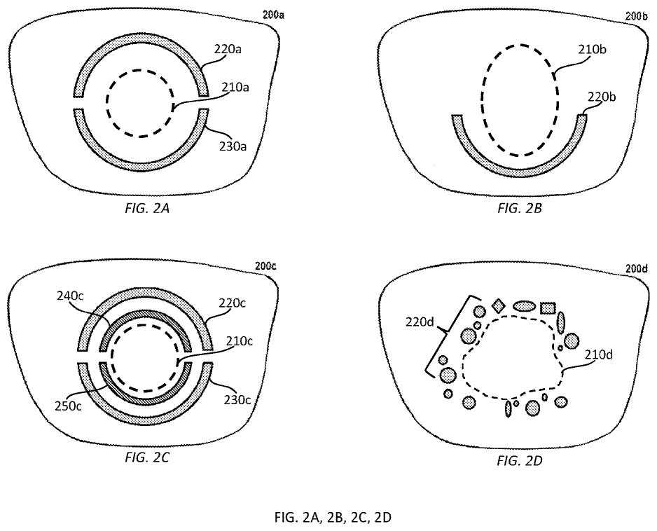

In addition to the use case of correcting ametropia, another use case is for controlling, reducing and/or reversing the progression of myopia (“myopia control”). For myopia control, one or more DFZs are positioned to surround a regularly or irregularly shaped FFZ (“surrounded FFZ”) 210a, 210b, 210c, 210d, when viewed from the front of a lens. A surrounded FFZ is a simply connected shape. FIG. 2 shows examples of DFLs with one or more DFZs and FFZs for the use case of myopia control.

In one embodiment of a DFL that performs myopia control, at least one of the optical center and geometric center of a surrounded FFZ is positioned at the at least one of an optical center and a geometric center of a DFL, when viewed from the front of a lens.

In another embodiment of a DFL that performs myopia control, at least one of an optical center and a geometric center of a DFL is encircled inside a surrounded FFZ, when viewed from the front of a lens.

In one embodiment of a DFL, the percentage ratio of the total optical area of all DFZ(s) to the entire optical area of the DFL is less than 65%, preferably less than 45%, and more preferably less than 30%.

In another embodiment of a DFL, the percentage ratio of the total optical area of all DFZ(s) to the entire optical area of the DFL is less than 25%, preferably less than 20%, and more preferably less than 15%.

When viewed from the front of a lens (i.e., the optical surface(s) of a lens): FIG. 2A shows a DFL 200a with two DFZs 220a, 230a, positioned outside of and around a circular FFZ 210a. FIG. 2B shows a DFL 200b with one DFZ 220b, positioned outside of and around an oval FFZ 210b. FIG. 2C shows a DFL 200c with four DFZs 220c, 230c, 240c, 250c, positioned outside of and around a circular FFZ 210c. FIG. 2D shows a DFL 200d with multiple DFZs (collectively 220d), positioned outside of and around an irregularly shaped FFZ 210d.

The optical area of an FFZ is at least 30 square mm, preferably at least 60 square mm, more preferably at least 120 square mm, even more preferably at least 180 square mm, yet more preferably at least 250 square mm, and furthermore preferably at least 350 square mm.

For myopia control, optical power(s) (“add power”) created by the DFZ(s) reduces the eye's natural peripheral hyperopic defocus, which reduces the progression of myopia over time. In contrast, the optical power, if any, in the FFZ corrects ametropia, for example ametropia of distance vision.

In one embodiment, an FFZ does not reduce the eye's peripheral hyperopic defocus.

Major functional differences between one or more DFZs designed for ametropia correction versus myopia control: (1) for ametropia correction, a DFZ's optical area, when activated (i.e., provides optical power), is for a wearer to see improved near vision and/or intermediate vision. Therefore, this type of DFZ's position in or on a DFL is suited for near vision and/or intermediate vision. In one embodiment, this type of DFZ (e.g., 120b in FIG. 1B) is positioned generally towards a wearer's nose. In another embodiment, this type of DFZ is positioned generally towards an optical center and/or a geometric center of a DFL comprising this type of DFZ. (2) for myopia control, one or more DFZs, when activated, is to reduce a wearer's eye(s) peripheral hyperopic defocus, and not to improve near and/or intermediate vision. Therefore, this type of DFZ's position in or on a DFL is suited for peripheral vision. In one embodiment, this type of DFZ (e.g., 220d in FIG. 2D) is positioned generally around an FFZ (e.g., 210d in FIG. 2D), with the FFZ comprising an optical center and/or a geometric center of a DFL. The DFL comprises this type of DFZ.

In one embodiment, a DFL comprises at least one optical, internal cavity that is optically inside or a component of at least one FFZ and is outside any DFZ (“Optical Internal Cavity” or “OIC”). Moreover, the at least one OIC is fluidically connected to at least one DFZ's own optical cavity. The at least one OIC comprises at least one optical working fluid (“OWF”). The at least one OIC transports, e.g., channels, at least a portion of the at least one OWF to and from the at least one DFZ (or equivalently, the at least one OIC is a conduit comprising one or more such fluidic transport pathways).

A location and an object, two objects or two locations are fluidically connected if a change in the fluid of (or in, on, at, under, over, surrounding, or otherwise in physical contact with) one location or object would physically induce any change in the fluid of (or in, on, at, under, over, surrounding, or otherwise in physical contact with) the other object or location.

In another embodiment, a DFL comprises at least one non-optical, or at least partially non-optical, cavity (“Non-Optical Cavity” or “NOC”) that is connected to at least one DFZ. The at least one NOC is optically outside any DFZ and is not itself a DFZ. The at least one NOC comprises at least one of: at least one OWF, and at least one structure housing the at least one OWF (e.g., a hollow tube). The at least one NOC transports at least a portion of the at least one OWF to and from the at least one DFZ (or equivalently, the at least one NOC is a conduit comprising one or more such fluidic transport pathways).

In yet another embodiment, at least one DFZ is connected to at least one structure, e.g., a hollow tube, that transports (equivalently, serves as a conduit for additional structure(s) that transport) at least a portion of at least one OWF to and from the at least one DFZ. Moreover, the at least one structure is separable (i.e., capable of being disassociated) from a DFL comprising the at least one DFZ (“Separable Conduit to DFZ” or “SCTD”). In contrast, an OIC and an NOC are not separable from a DFZ, but rather these two types of cavities are integrated with, within, into and/or onto a DFZ.

Controlling the internal pressure and/or volume of an OWF controllably changes the flexible geometry of an DFZ in a controlled manner, which together with the refractive index differential between the OWF and air, change the DFZ's focal length and optical power. The careful control of a DFZ's optical power, measured in optical diopter (“OD”), controls the amount of ametropia correction and/or myopia control provided by the DFL. The activation, deactivation and control of any dynamic optical power, in a DFZ is directly or indirectly (1) controlled by the wearer, and/or (2) controlled by one or more electromechanical subsystems of the Integrated Eyewear.

In this invention, an optical area can have any optical power, e.g., positive, zero (comprising substantially zero) and negative optical power(s).

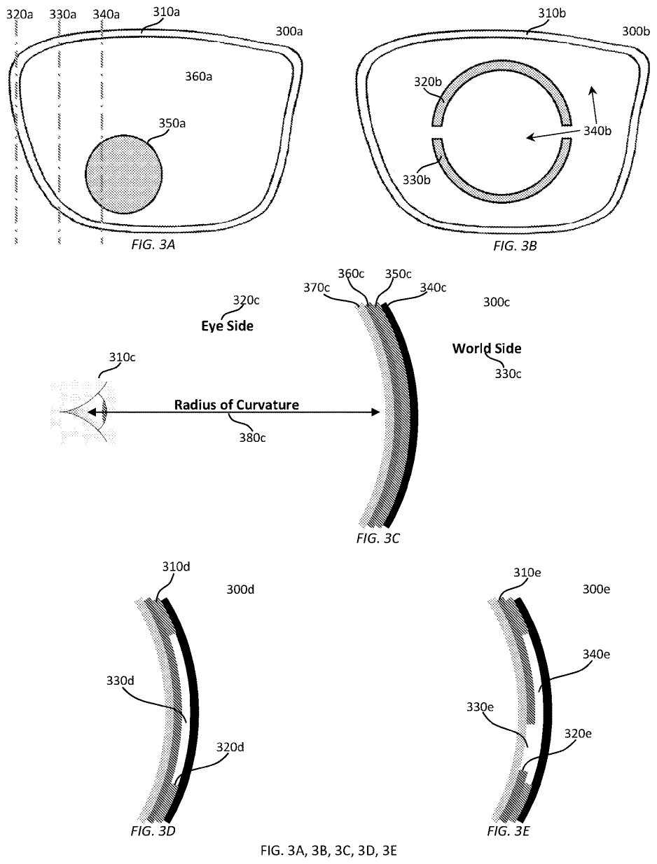

FIG. 3A through FIG. 3E show two example DFLs and cross-sections showing lens construction. FIG. 3A 300a shows a DFL with one DFZ 350a and one FFZ 360a for the purpose of correcting ametropia. A border 310a around the DFL is comprised of one or more OWF-impermeable materials.

In another embodiment, a construction of a DFL at its three cross-sections at 320a, 330a and 340a are shown in FIG. 3C 300c, FIG. 3D 300d, and FIG. 3E 300e, respectively.

In one embodiment, FIG. 3B 300b shows a DFL with two DFZs 320b, 330b and one FFZ 340b for the purpose of controlling myopia. The border 310b also fully or partially encapsulates at least one OWF.

In some embodiments, a border also comprises at least one of (1) one or more sealants and (2) one or more adhesives that fully or partially encapsulates at least one OWF and prevents the OWF from leaking.

FIG. 3C 300c shows an example construction of a DFL at a cross-section 320a of the DFL's border (i.e., perimeter). The cross-section can be flat, or preferably curved. In some embodiments where a DFL is curved, the average curvature of the DFL is towards a wearer's eye 310c, as shown in 300c. The radius of curvature (“ROC”) 380c is positive when the DFL on average curves towards the eye 310c, i.e., towards eye side 320c, and is negative when the DFL on average curves towards world side 330c. The ROC is approximately equal to 523 mm divided by the base curve. For example, a lens with base curve 4 has a ROC of approximately 130 mm or preferably between 120 mm and 140 mm, and a lens with base curve 6 has a ROC of approximately 85 mm or preferably between 75 mm and 95 mm. Base curve is measured from an uncut, unprocessed lens blank, e.g., a semi-finished lens blank.

In an embodiment, the average base curve of the back surface (i.e., inside optical surface facing eye side) of a DFL, outside of any DFZ, ranges between 0 and 10, preferably between 0 and 8, more preferably between 0 and 6.5, and even more preferably between 2 and 6.5, inclusively.

In one embodiment, cross-sectionally a DFL is comprised of at least two features, preferably at least four features 340c, 350c, 360c and 370c, as shown in FIG. 3C 300c. FIG. 3A 300a shows a location 320a of the perimeter of a DFL, with its cross-section shown in FIG. 3C 300c. The features are bonded together (e.g., chemically bonded, electrostatically bonded, thermally bonded, pressure bonded, laminated together, held together) and/or are otherwise physically connected, to prevent leakage of one or more OWFs.

In one embodiment, a rigid front layer (“RFL”) 340c is an outermost, rigid, transmissive optical feature, e.g., a hard optical layer, closest to the world side 330c. A perimeter spacer (“IPS”) 350c is a non-optical feature that acts as a spacer. A stiffness control feature (“SCF”) 360c is a transmissive optical and mechanical feature (e.g., an optical material layer) that controls or modulates the flexure of a flexible optical power layer (“FOPL”) 370c, e.g., when under pressure from an OWF. A FOPL is a flexible, transmissive optical feature physically connected to at least one SCF.

In a DFL, outside of any DFZ, a plano or non-plano SCF, i.e., a SCF having zero or nonzero optical power(s) in optical areas outside of any DFZ, comprises an average base curve of between 0 and 10, preferably between 2 and 8, more preferably between 2 and 6, and even more preferably between 4 and 6, inclusively.

In some embodiments, a FOPL is a transmissive optical feature of a DFL closest to a wearer's eye.

In some other embodiments, there is at least one additional optical feature of a DFL between a wearer's eye and a FOPL. For example, such additional optical feature(s) can comprise an optomechanical layer of polymer or glass material that protects a FOPL from damage.

An RFL is a stiff optical layer designed to be rigid. However, it may flex a minuscule amount when there is a change in the volume and/or internal pressure of an OWF in the one or more OICs and DFZs of a DFL. An RFL can carry any static optical power, i.e., a static optical prescription, (“s-Rx”), e.g., positive, negative, and zero or substantially zero optical power (“plano” or “substantially plano”, respectively).

In one embodiment, an s-Rx on the RFL corrects or improves at least one of (1) distance vision, (2) intermediate vision, and (3) near vision.

In a preferred embodiment, an s-Rx on the RFL corrects or improves distance vision.

In another preferred embodiment, an s-Rx on the RFL corrects or improves distance and intermediate vision.

In one embodiment, an s-Rx on the SCF corrects or improves at least one of (1) distance vision, (2) intermediate vision, and (3) near vision.

An IPS is a non-optical feature, e.g., a polymer layer, which acts as a spacer between an RFL and an SCF to create one or more cavity (ies), e.g., OIC(s), DFZs, and/or NOCs, in a DFL. At least one of the cavity (ies) is filled with a OWF. The IPS is preferably not easily visible to a wearer on the eye-side or a person on the world-side.

In one embodiment, an eyewear's frame can partially or completely hide an IPS's visibility.

In another embodiment, the refractive index of an OWF, which shares one or more interfaces with (e.g., touches) an IPS, is the same or very similar to the average refractive index of an IPS. For example, when tested at 25° C. the magnitude of the difference in the refractive indices of an IPS and an OWF is within 0.20, preferably within 0.15, more preferably within 0.08, even more preferably within 0.04 and yet more preferably within 0.02.

The average refractive index of an optical material is measured by its refractive index along its optical axis.

In one embodiment, an IPS comprises a stiff material that is impermeable by an OWF.

A FOPL comprises one or more layers of flexible material(s), e.g., film(s), that controllably changes shape when experiencing a difference in pressure applied on its two optical surfaces, where one surface faces eye-side and the other faces world-side.

In one embodiment, pressure on a FOPL's surface facing eye side is atmospheric pressure.

Pressure indications, e.g., in atm, are absolute pressures, not gauge pressures.

In another embodiment, within an optical area of a DFZ, pressure on a FOPL's surface facing world side is an OWF's internal liquid pressure. A FOPL's shape changes in a DFZ is due to a change in an OWF's internal pressure and/or volume.

In one embodiment, an FOPL's thickness is uniform.

In another embodiment, an FOPL's thickness is nonuniform.

An SCF comprises one or more material(s) that add stiffness to those areas of a FOPL that are bonded to or otherwise connected to the SCF. An SCF's stiffness is tuned by its geometry and material properties.

In one embodiment, an SCF is comprised of the same material as that of an FOPL.

In another embodiment, an SCF is comprised of a different material as that of an FOPL.

In one embodiment, an SCF comprises one or more layers of optical material(s), and an SCF's thickness is uniform in optical area of an FFZ.

In another embodiment, an SCF's thickness is nonuniform in optical area of an FFZ.

In some embodiments, an FOPL and an SCF are separable components, and are bonded together to form a part of a DFL.

In some other embodiments, an FOPL and an SCF are not separable components, but instead are two physical features of one component, and these physical features do not require bonding to form the one component. For example, a single polymer component can be injection molded or casted to comprise or form one or more FOPL features and one or more SCF features.

In one or more embodiments, an SCF and an IPS are not separable components, but instead are two physical features of one component, and these physical features do not require bonding to form the one component. For example, a single polymer component can be injection molded or casted to comprise or form one or more SCF features and one or more IPS features.

In other embodiments, an FOPL, an SCF and an IPS are not separable components, but instead are three physical features of one component, and these physical features do not require bonding to form the one component. For example, a single polymer component can be injection molded or casted to comprise or form one or more FOPL features, one or more SCF features and one or more IPS features.

In one embodiment, an RFL and an IPS are not separable parts, but instead both are features of one part (i.e., component), and these features do not require bonding to form the part. For example, a single polymer component can be injection molded or casted to comprise or form one or more RFL features and one or more IPS features.

FIG. 3D 300d shows a cross-section of a DFL at location 330a in FIG. 3A 300a. At this cross section, an IPS only exists at upper 310d and lower 320d portions of the DFL and is further prescribed by the DFL's perimeter wall 310a. The IPS creates an OIC 330d in a DFL, and this cavity comprises (i.e., is filled with) and transports (i.e., channels) at least one OWF.

This OIC 330d, 340e is surrounded by a RFL, an SCF and an IPS, which prevent an OWF from leakage. An optical area at location 330a is an FFZ 360a, which is tailored, e.g., has an s-Rx, for a wearer's at least one of (1) distance vision, and (2) intermediate vision. In the case of a FFZ being fit for both distance vision and intermediate vision, it means certain subarea(s) of the FFZ is (are) tailored for distance vision, while other subarea(s) is (are) tailored for intermediate vision.

FIG. 3E 300e shows a cross-section of a DFL at location 340a in FIG. 3A 300a. At this cross section, an SCF has a cavity (i.e., a void) 330e, an upper 310e portion and a lower 320e portion. In a DFZ, the cavity 330e is filled with an OWF, i.e., a DFZ comprises a cavity and such cavity comprises an OWF. This cavity of DFZ is surrounded by a RFL, an SCF, an IPS and an FOPL, which prevent an OWF from leakage. The FFZ 360a at location 340a is tailored for a wearer's at least one of (1) distance vision, (2) intermediate vision, and (3) near vision. The DFZ 350a at location 340a comprises a cavity 330e. A DFZ's optical power is dynamically controlled or tuned by shaping a FOPL through controlling the volume and/or internal pressure of an OWF that shares one or more interfaces with the FOPL. The OIC 330d, 340e channels an OWF to move a portion of the OWF to and from the DFZ 350a comprising the cavity 330e.

In some embodiments, an s-Rx of an FFZ is partially or completely caused by (1) an s-Rx created on a frontside (i.e., facing world side) optical surface of an RFL, (2) an s-Rx created on a backside (i.e., facing eye side) optical surface of an RFL, or (3) two s-Rxs with each created on each front- and back-side optical surfaces of an RFL. Preferably, an s-Rx of an FFZ is partially or completely caused by an s-Rx created on a frontside optical surface of an RFL.

Dynamic add power(s) (“d-Rx(s)”) in a DFZ are in addition to s-Rx. At any instant, the combination (i.e., sum) of d-Rx and s-Rx in a DFZ is total Rx (“t-Rx”).

In certain use cases when d-Rx is not needed in a DFZ, such as when using distance vision needing only s-Rx (i.e., non-plano or plano s-Rx), then d-Rx can be controlled to be between-0.2 diopter and 0.2 diopter, where plano d-Rx is also achievable. This state is called “d-Rx OFF”.

In other use cases when d-Rx is desired in a DFZ, such as when using near vision needing d-Rx and s-Rx, then d-Rx can be controlled to produce at least 0.2 diopter. This state is called “d-Rx ON”.

In some embodiments, a DFZ in a DFL has its own dynamic add power, independent of that of any other DFZ in a DFL with two or more DFZs. This independency of dynamic add power of one DFZ from another DFZ allows their optical powers to be different or the same.

In one embodiment of ametropia correction, preferably presbyopia correction, a DFZ's t-Rx (1) in a d-Rx OFF state, enables or improves at least one of distance vision and intermediate vision, and (2) in a d-Rx ON state, is controlled to improve a wearer's at least one of near vision and intermediate vision.

In one embodiment of myopia control, a DFZ's t-Rx (1) in a d-Rx OFF state, enables or improves a wearer's distance vision, and (2) in a d-Rx ON state, reduces or corrects a wearer's peripheral hyperopic defocus by providing a d-Rx add power in addition to an s-Rx tailored for distance vision. For myopia control use cases, a wearer's eye(s) maintains natural accommodative capability, e.g., an s-Rx correction to distance vision also enables good intermediate and near vision via natural accommodation of the eyes.

For the embodiment shown in FIG. 3A and its three cross-sections shown in FIGS. 3C, 3D and 3E, an FOPL bonded or connected to an SCF, (1) creates, or is capable of creating, a DFZ 350a having a cavity (i.e., void) 330e in an SCF, and (2) creates, or is capable of creating, an FFZ 360a not having any cavity (i.e., void) in an SCF 310e, 320e.

A DFZ creates, or is capable of creating, a d-Rx of at least 0.2 OD by an Integrated Eyewear controlling an OWF's internal pressure and/or volume.

Even an FFZ having a stiff SCF may have the SCF minimally flex under an OWF's internal pressure with such loading primarily intended to increase d-Rx in a DFZ. The minimal flexure of an SCF can cause a minimal d-Rx in an FFZ. Therefore, 0.2 OD is a practical threshold of d-Rx which separates a DFZ from an FFZ. I.e., an FFZ creates, or is capable of creating, a d-Rx of less than 0.2 OD by an Integrated Eyewear controlling an OWF's internal pressure and/or volume.

In this specification, (1) a FOPL refers an FOPL part (i.e., component) or an FOPL feature of a part comprising two or more features, unless otherwise specified, (2) an IPS refers an IPS part or an IPS feature of a part comprising two or more features, unless otherwise specified, (3) an RFL refers a RFL part or a RFL feature of a part comprising two or more features, unless otherwise specified, and (4) an SCF refers an SCF part or an SCF feature of a part comprising two or more features, unless otherwise specified.

For clarity in language, a single component that contains only one feature is equivalent to that feature itself, e.g., a single component containing only an RFL feature is equivalent to an RFL.

A DFZ and an FFZ can both have any s-Rx.

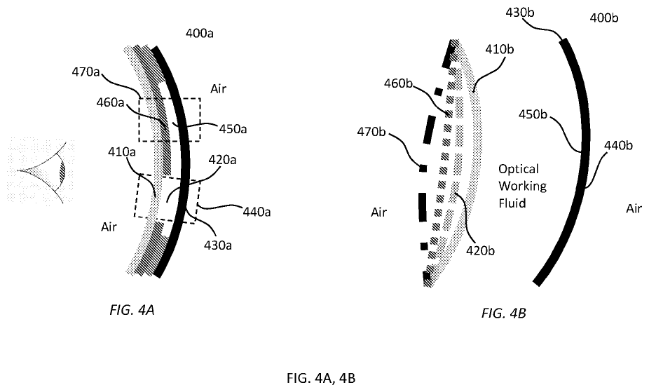

FIG. 4A and FIG. 4B schematically illustrate that the optical power in a DFZ 440a is or capable of being changed or controlled by commensurately changing or controlling the geometry of a FOPL 410a in the DFZ.

FIG. 4A 400a illustrates a cross-section at 340a of a DFL in FIG. 3A. The DFL comprises a DFZ with cross-sectional view 440a and frontal view 350a, and an FFZ with a cross-sectional view 470a and frontal view 360a. Cross-sectionally, the DFZ 440a comprises an FOPL 410a, an internal cavity 420a, an OWF filling the internal cavity 420a and a RFL 430a. Cross-sectionally, the FFZ 470a comprises the same FOPL 410a, an OIC 450a, the same OWF filling internal cavities 450a and 420a, an SCF 460a and the same RFL 430a.

The DFZ's internal cavity 420a and the OIC 450a are fluidically connected. Internal cavity 420a of a DFZ comprise a void in the material of an SCF. At steady-state condition of the DFL, an OWF's internal pressures in fluidically connected cavities in a DFL are the same or substantially the same. Therefore, any change in an OWF's internal pressure (i.e., pressure, hydraulic pressure) in a cavity of a DFZ (e.g., to control d-Rx via FOPL flexure) would equally or substantially equally change the OWF's internal pressure in a cavity of an FFZ, e.g., an OIC, provided the two or more cavities are fluidically connected.

In an optical area of a DFZ, incident light from world side enters through RFL 430a, passes through an internal cavity 420a comprising an OWF, and exits through FOPL 410a.

In an optical area of an FFZ, incident light from world side enters through RFL 430a, passes through an OIC 450a comprising an OWF, further passes through an SCF 460a and exits through FOPL 410a.

Both world side and eye side comprise air with a refractive index of 1.0.

The average refractive index of a RFL is between 1.30 and 2.00, preferably between 1.40 and 1.79, more preferably between 1.45 and 1.75, and even more preferably between 1.47 and 1.65.

The average refractive index of a SCF is between 1.30 and 2.00, preferably between 1.40 and 1.75, more preferably between 1.45 and 1.68, and even more preferably between 1.47 and 1.61.

The average refractive index of a FOPL is between 1.32 and 2.00, preferably between 1.40 and 1.75, and more preferably between 1.45 and 1.69.

The refractive index of an OWF when tested at 25° C. is between 1.30 and 1.80, preferably between 1.40 and 1.75, more preferably between 1.44 and 1.65, and even more preferably between 1.44 and 1.61.

In some examples, there is at least one optical adhesive in an optical area of a DFL. For example, an optical adhesive between an SCF and an FOPL to adhere them together. In these examples, an average refractive index of such optical adhesive is between 1.30 and 2.00, preferably between 1.40 and 1.75, more preferably between 1.45 and 1.68, and even more preferably between 1.45 and 1.62.

FIG. 4A illustrates an exemplary cross-section of a DFL 400a comprising (1) a DFZ 440a capable of providing static and dynamic optical powers, i.e., at least one s-Rx and at least one d-Rx respectively, and (2) a FFZ 470a capable of providing at least one s-Rx.

FIG. 4B 400b is an enlarged illustration of an exemplary cross-section of the DFZ 440a in FIG. 4A, with various states of flexure of an FOPL 410b, 420b, 460b and 470b. An RFL 430b is plano or substantially plano in the figure, but it can have at least one s-Rx on at least one of (1) its outer optical surface 440b, which is in contact with air, and/or (2) its inner optical surface 450b, which is in contact with at least one OWF. A FOPL is shown in a d-Rx OFF state 410b, where the FOPL's ROC is the same as, substantially the same as or similar to, the ROC of the base curve or a plano optical surface of the RFL.

In one embodiment, an RFL's inner optical surface 450b is plano or substantially plano, with this surface in contact with at least one OWF.

In another embodiment, an RFL's outer optical surface 440b is plano or substantially plano, with this surface in contact with air.

As shown in FIG. 4B 400b, for a small amount of d-Rx, e.g., between minimum 0.2 OD and maximum 1.75 OD, an example flexure of an FOPL 420b is illustrated for a d-Rx ON state, where the example FOPL's ROC corresponding to d-Rx ON is larger than the FOPL's ROC in a d-Rx OFF state 410b, i.e., FOPL is less curved (i.e., flatter) for the d-Rx ON state than for the d-Rx OFF state. The direction of curvature (“DOC”) of an example FOPL in the d-Rx OFF 410b and d-Rx ON 420b states are the same DOC of an RFL's plano optical surface, e.g., 450b in FIG. 4B. In a DFZ, the inner optical surface of a FOPL is in contact with an OWF; and the outer optical surface of a FOPL is in contact with air. Note that a plano or substantially plano lens, i.e., zero or substantially zero optical power (respectively), can have a curved and/or flat shape.

As shown in FIG. 4B 400b, for a large amount of d-Rx, e.g., between minimum 1.75 OD and maximum 2.5 OD, preferably between min of 1.75 OD and max of 3.5 OD, an example FOPL is illustrated in another d-Rx ON state 460b, where the example FOPL's ROC is much larger than the FOPL's ROC in the d-Rx OFF state 410b, and is also larger than the FOPL's ROC in the d-Rx ON state 420b for a smaller amount of d-Rx. I.e., the example FOPL in the d-Rx ON state 460b is flatter than if or when the FOPL is in the d-Rx OFF state 410b and in the d-Rx ON state 420b for a smaller amount of d-Rx. The DOC of this example FOPL in the d-Rx ON state 460b is the same DOC of an RFL's inner optical surface 450b.

As shown in FIG. 4B 400b, for an even larger amount of d-Rx, e.g., larger than 2.5 OD, preferably larger than 3.5 OD, an example FOPL is illustrated in yet another d-Rx ON state 470b, where the example FOPL in this d-Rx ON state 470b has an opposite DOC than a DOC of an RFL's inner optical surface 450b.

As shown in FIG. 4B 400b, comparing cross-sectional shapes of an FOPL 410b, 420b, 460b and 470b, a positive d-Rx is created by an FOPL's flexure away from an RFL and towards a wearer's eye. The more positive the d-RX, the more away from an RFL the FOPL flexes in a DFZ.

As shown in FIG. 4B 400b, comparing the cross-sectional shapes of a FOPL 410b, 420b, 460b and 470b, a smaller, sometimes plano or substantially plano, d-Rx is created by an FOPL's flexure towards an RFL and away from the eye. The less positive the d-RX, the more towards an RFL the FOPL flexes in a DFZ.

In one embodiment, each amount of an OWF's fluidic pressure exerted on a FOPL causes the FOPL in a DFZ to attain a commensurate flexure shape. Therefore, a DFZ can produce at least one d-Rx for the entire or substantially entire optical area of the DFZ. Furthermore, a DFZ can produce a range of d-Rx(s) by an OWF achieving a commensurate range of fluidic pressures acting on a FOPL. An OWF is internal to a DFL, and the OWF is in physical contact with a FOPL. A fluidic pressure of an OWF acting on a FOPL can be achieved by controlling the amount of OWF volume inside a DFL and external mechanical pressure exerted on the OWF.

In some embodiments, for each dynamically controlled, cross-sectional shape, i.e., flexure shape, of a FOPL, the entire or substantially entire optical area of a DFZ can produce one or more uniform (or substantially uniform) d-Rx, and the DFZ can comprise one or more s-Rx(s) on an RFL. A DFZ produces a uniform d-Rx by controlling the internal (i.e., fluidic) pressure and/or volume of an OWF in a DFL.

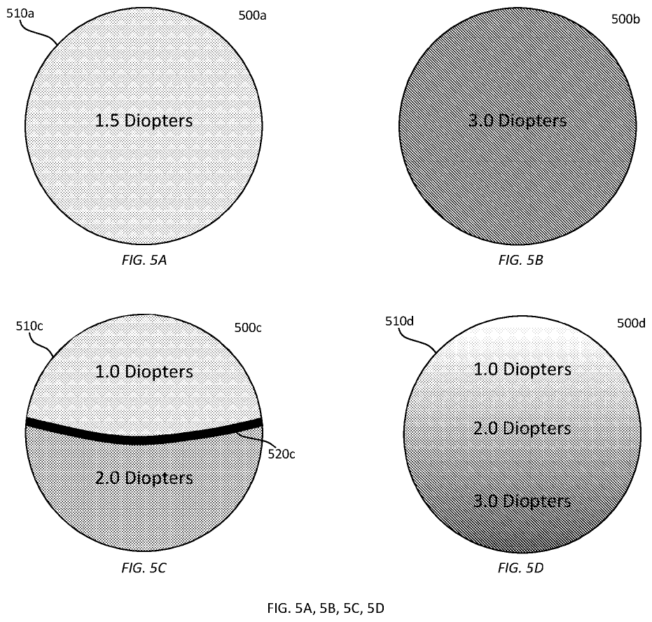

As illustrated in FIG. 5A 500a, a DFZ produces a uniform add power having a d-Rx of 1.5 OD in the optical area 510a of the DFZ. Comparatively, a DFZ produces a higher uniform d-Rx by having a higher internal pressure and/or a larger volume of an OWF in a DFL. As illustrated in FIG. 5B 500b, a DFZ produces a higher uniform add power having a d-Rx of 3.0 OD in the optical area of the DFZ under a higher OWF pressure loading.

In other embodiments, for each dynamically controlled, cross-sectional shape of a FOPL, the entire or substantially entire optical area of a DFZ can produce nonuniform d-Rx(s), e.g., bifocal, multifocal or progressive add powers. A DFZ produces nonuniform dynamic add powers by controlling the internal pressure and/or volume of a OWF in a DFL, and by having at least one of (1) an FOPL having a nonuniform cross-sectional thickness, and (2) a SCF and a FOPL each having a nonuniform cross-sectional thickness. As illustrated in FIG. 5C 500c, a DFZ produces bifocal add powers having d-Rx(s) of 1.0 OD and 2.0 OD, with a bifocal separation 520c, in the optical area 510c of the DFZ. In the same embodiment, a DFZ produces a higher nonuniform d-Rx(s) by having a higher internal pressure and a larger volume of an OWF in a DFL. For example, the same DFZ produces higher bifocal add powers having d-Rx(s) of 1.5 OD and 3.0 OD in the optical area of the DFZ under a higher OWF pressure loading.

In another embodiment, a DFZ produces progressive add powers having continuous d-Rx(s) without multifocal separation by controlling the internal pressure and/or volume of a OWF in a DFL, and by having at least one of (1) a FOPL having a nonuniform cross-sectional thickness, and (2) a SCF and a FOPL each having a nonuniform cross-sectional thickness. As illustrated in FIG. 5D 500d, a DFZ produces progressive add powers having d-Rx(s) smoothly ranging from 1.0 OD to 3.0 OD, without having multifocal separation lines (or curves) in the optical area 510d of the DFZ. In the same embodiment, a DFZ produces lower nonuniform d-Rx(s) by having a lower internal pressure and a smaller volume of the OWF in a DFL. For example, the same DFZ produces lower progressive add powers having d-Rx(s) smoothly ranging from 0.5 OD to 2.5 OD, without multifocal separation in the optical area of the DFZ under a lower OWF pressure loading.

In one embodiment, a DFL comprises a multi-feature component, and the component comprises at least one of an RFL (i.e., RFL feature), an IPS (i.e., IPS feature), an SCF (i.e., SCF feature) and an FOPL (i.e., FOPL feature).

In another embodiment, a DFL comprises a multi-feature component, and the component comprises at least one of an RFL (i.e., RFL feature), an IPS (i.e., IPS feature), and an FOPL (i.e., FOPL feature).

In one embodiment, a DFL comprises a multi-feature component, and the component comprises at least one of an RFL (i.e., RFL feature), an SCF (i.e., SCF feature), and an FOPL (i.e., FOPL feature).

In another embodiment, a DFL comprises a multi-feature component, and the component comprises at least one of an RFL (i.e., RFL feature), an SCF (i.e., SCF feature), and an IPS (i.e., IPS feature).

A circular DFZ, such as FIG. 1A 120a, capable of producing uniform or substantially uniform d-Rx(s), is comprised of (1) an SCF and an FOPL (equivalently an SCF feature and a FOPL feature of a single component) each having its own uniform cross-sectional thickness, (2) the SCF comprise a circular void, with the perimeter of the void forming the perimeter of the circular DFZ, and (3) an OWF, which shares a liquid-solid interface with the FOPL in the DFZ, capable of exerting uniform fluidic pressure(s) on the interface. The resultant flexure of the FOPL in a DFZ is of a shape that approximates a spherical dome, which produces uniform or substantially uniform d-Rx(s) with good image quality.

A noncircular DFZ, such as FIG. 1B 120b, capable of producing uniform or substantially uniform d-Rx(s) in an optical area, such as 130b, within the DFZ with such optical area having an equal or smaller area than that of the DFZ, is comprised of (1) an SCF and an FOPL (equivalently an SCF feature and a FOPL feature of a single component) with at least one of the SCF and the FOPL having a nonuniform cross-sectional thickness, preferably the FOPL has a nonuniform cross-sectional thickness, (2) the SCF has a noncircular void (i.e., noncircular hole), with the perimeter of the void forming the perimeter of the noncircular DFZ, and (3) an OWF, which shares a liquid-solid interface with the FOPL in the DFZ, capable of exerting uniform fluidic pressure(s) on the interface.

In one embodiment of a noncircular, e.g., oval, semi-circular, semi-oval, DFZ FIG. 1B 120b, FIG. 1C 120c, capable of producing uniform or substantially uniform d-Rx(s) in an optical area 130b within the DFZ 120b with such optical area 130b having an equal or smaller area than that of the DFZ 120b, comprises (1) a 45-degree axis 140b from the horizontal and a −45-degree axis 150b defined by an axis that perpendicularly bisects the 45-degree axis 140b, and the −45-degree axis also passes through the centroid of the DFZ, (2) the four quadrants of optical areas 160b, 170b, 180b, 190b created by the 45- and −45-degree axes, (3) the two quadrants with the larger optical areas, each has an average cross-sectional thickness of an FOPL over the entire quadrant that is thicker, preferably thicker by at least 10%, than the average cross-sectional thickness of the FOPL over the entire DFZ, and (4) the two quadrants with the smaller optical areas, each has an average cross-sectional thickness of the FOPL over the entire quadrant that is thinner, preferably thinner by at least 10%, than the average cross-sectional thickness of the FOPL over the entire DFZ. The denominator in these percentage calculations is the average cross-sectional thickness of the FOPL over the entire DFZ. The numerator in these percentage calculations is the average cross-sectional thickness of the FOPL over the entire selected quadrant.

In one embodiment of a DFZ capable of producing a bi-focal d-Rx in its optical area, e.g., FIG. 5C 510c, comprises a thin d-Rx transition region (e.g., 520c) that bifurcates the optical area of the DFZ into two smaller optical areas with one such smaller area having a higher d-Rx and the other smaller area having a lower d-Rx, and a FOPL in the DFZ that covers both smaller optical areas. For the one optical area having a higher d-Rx, the average cross-sectional thickness of the FOPL covering this optical area is thinner. For the other optical area having a lower d-Rx, the average cross-sectional thickness of the same FOPL covering this optical area is thicker. Preferably, for the FOPL in the DFZ, the ratio of its thicker average cross-sectional thickness for the higher d-Rx optical area to its thinner average cross-sectional thickness for the lower d-Rx optical area is at least 1.1. The optical area of the thin d-Rx transition region is no more than 23% of the entire optical area of the DFZ. Furthermore, the FOPL's cross-sectional thickness abruptly or rapidly changes in the thin d-Rx transition region, where this abrupt or rapid thickness change creates the thin d-Rx transition region 520c.

In another embodiment of a DFZ capable of producing progressive d-Rx(s) in its optical area, e.g., FIG. 5D 510d, the DFZ does not comprise any thin d-Rx transition region (e.g., FIG. 5C 520c) that bifurcates the optical area of the DFZ into two or more smaller optical areas with one smaller area having a higher d-Rx and another smaller area having a lower d-Rx. Instead, the DFZ comprises a FOPL that covers the entire optical area of the DFZ, and the cross-sectional thicknesses of the FOPL changes smoothly or gradually in the DFZ, such that the optical area of the DFZ comprises gradually varied d-Rx(s) and does not comprise any thin d-Rx transition region with rapid changes. For the one optical area having a higher d-Rx, the average cross-sectional thickness of the FOPL covering this optical area is thinner. For the other optical area having a lower d-Rx, the average cross-sectional thickness of the same FOPL covering this optical area is thicker. Preferably, for the FOPL in the DFZ, the ratio of its thicker average cross-sectional thickness for the lower d-Rx optical area to its thinner average cross-sectional thickness for the higher d-Rx optical area is at least 1.1.

For ametropia correction, the dynamic add power, d-Rx, in a DFZ is capable of having a range from minimum 0.2 diopter to maximum 8.0 diopter, preferably from min 0.2 diopter to max 6.0 diopter, and more preferably from min 0.2 diopter to max 4.0 diopter. These d-Rx ranges are applicable to both uniform and nonuniform d-Rx(s) produced in the optical area of a DFZ under any controlled OWF fluidic pressure on a FOPL in the DFZ.

For myopia control, d-Rx in a DFZ is capable of having a range from min 0.2 diopter to max 10.0 diopter, preferably from min 0.5 diopter to max 8.0 diopter and more preferably from min 1 diopter to max 6.0 diopter. These d-Rx ranges are applicable to both uniform and nonuniform d-Rx(s) produced in the optical area of a DFZ under any controlled OWF fluidic pressure on a FOPL in the DFZ.

For certain performance applications needing very large magnifications, such as bird watching, hunting, jewelry working and microelectronics repairing, d-Rx in a DFZ is capable of having a range from min 0.2 diopter to max 10.0 diopter, preferably from min 0.2 diopter to max 40.0 diopter and more preferably from min 0.2 diopter to max 80.0 diopter. These d-Rx ranges are applicable to both uniform and nonuniform d-Rx(s) produced in the optical area of a DFZ under any controlled OWF fluidic pressure on a FOPL in the DFZ.

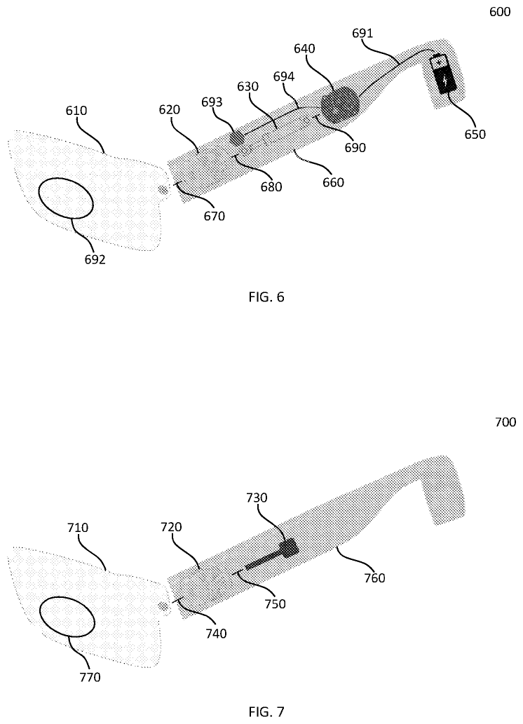

At least one OWF in a DFL or in a fluid reservoir that is fluidically connected to a DFL, can be actuated electromechanically or manual-mechanically in order to controllably change d-Rx(s) of the at least one DFZ. Actuation of the at least one OWF increases or decreases the OWF(s)'s internal pressure inside the cavity of at least one DFZ, and inside one or more of: at least one OIC, at least one NOC and at least one SCTD. Consequently, actuating an OWF controllably actuates a FOPL, in order to controllably create or change (e.g., increase or decrease) d-Rx(s) of at least one DFZ. Actuation of an OWF is (1) to push a portion of an OWF from outside of the cavity (ies) of at least one DFZ into such cavity (ies), e.g., move a portion of an OWF out of at least one reservoir, through an OIC, a NOC and/or a SCTD, into at least one DFZ, and/or (2) to extract a portion of an OWF from inside of the cavity (ies) of at least one DFZ out of such cavity (ies), e.g., move a portion of an OWF out of at least one DFZ, through an OIC, a NOC and/or a SCTD, into at least one reservoir. Actuation of a FOPL via controlling an OWF's fluidic pressure is to controllably change the cross-sectional shape or flexure of the FOPL. A cavity of a DFZ 692 in FIG. 6 is a cavity within a DFL 610, and such cavity transmits light within an optical area of the DFZ 692. Moreover, such cavity of a DFZ comprises a void in the material of an SCF. The cross-section of a DFZ's cavity is exemplified by the DFZ's cavity 330e in FIG. 3E and the DFZ's cavity 420a in FIG. 4A.

In one embodiment, a fluid reservoir is external to a DFL and is fluidically connected to a DFL. This fluidic connection can be achieved between a reservoir and a DFL by both the reservoir and DFL either (1) being directly next to and physically connected to each other in order to allow the movement of at least one OWF between the reservoir and DFL, or (2) being physically connected to at least one intermediary fluidic structure which exists in-between the reservoir and DFL in order to allow movement of at least one OWF between the reservoir, the at least one intermediary fluidic structure and DFL. Movement of at least one OWF between and within these eyewear components can be unidirectional, bidirectional or multidirectional. An intermediary fluidic structure can be a hollow tube or any other object that allows OWF movement within it.

FIG. 6 600 is an example schematic of an electromechanically actuatable DFL 610 comprised of electrical and mechanical reservoir and actuation components 620, 630, 640 and 650 inside or on an Integrated Eyewear frame and/or the DFL, preferably inside or on one or more frame temples 660 or the DFL. A reservoir 620 with at least one OWF inside is fluidically connected 670 to a DFL 610 which comprises a DFZ 692. In one embodiment, an electromechanical actuator (“EM-actuator”) 630 actuates a reservoir 620. An EM-actuator can be at least mechanically connected 680, preferably physically connected, to a reservoir 620. (Mechanical connection comprises one or more of physical, fluidic, and magnetic connection.) At least one electronic controller (“EC”) 640, in a format such as a printed circuit board (“PCB”), is at least communicatively connected 690, preferably communicatively and electrically connected, to an EM-actuator 630. At least one EC 640 is electrically connected 691 to at least one power source 650, such as a rechargeable battery. Two communicatively connected components allow communication of information, data, feedback signals and/or other signals between these connected components, and such connection can be wired or wireless.

In one embodiment, at least one of a reservoir (i.e., fluidic reservoir) and an EM-actuator are electrically connected to at least one of a power source and an EC.

In yet another embodiment, at least one actuation command sensor (“ACS”), illustrated in FIG. 6 693, is at least one of (1) communicatively connected 694 to at least one EC 640, (2) electrically connected 694 to at least one EC 640, and (3) electrically connected to at least one power source 650. At least one ACS receives a command (i.e., operative instruction), preferably an external command, more preferably an external command from a human wearer, (1) to activate at least one, preferably two or more, DFZ(s) from d-Rx OFF to d-Rx ON (“DFZ activation”), (2) to deactivate at least one, preferably two or more, DFZ(s) from d-Rx ON to d-Rx OFF (“DFZ deactivation”), or (3) to change the amount of d-Rx optical power in at least one DFZ (“DFZ OD change”).

Unless specifically indicated otherwise, the words “commands”, “operative instructions” and “operatively instructs” have equivalent meaning and are used interchangeably.

In some embodiments, at least one ACS comprises at least one of tilt sensor(s), accelerometer(s), gyro(s), touch sensor(s), microphone(s), voice-recognition device(s), eye-tracking device(s) and wireless signal receiver(s). The at least one ACS may or may not be physically integrated within any EC. An ACS may be placed anywhere in, on or attached to a DFL and/or the frame of an Integrated Eyewear.

The process of DFZ activation, DFZ deactivation or DFZ OD change (“DFZ State Change Process”) for an Integrated Eyewear with one or more EM-actuators comprises: (1) at least one ACS receives a command, such as a finger touch from a user, (2) at least one EC receives and processes the command, and directs at least one EM-actuator to change its physical state, (3) the at least one EM-actuator receives command from the at least one EC and changes its physical state in order to reduce or expand the internal volume of at least one reservoir, (4) at least one OWF flows out of or into the at least one reservoir, (5) the at least one OWF flows into or out of at least one DFL, (6) the volume and/or internal pressure of the at least one OWF increases or decreases in the cavity (ies) of at least one DFZ, (7) a FOPL of the at least one DFZ changes shape, e.g., flexes towards or away from the eye, and (8) d-Rx(s) increase to achieve DFZ activation, d-Rx(s) decrease to achieve DFZ deactivation or d-Rx(s) change to achieve DFZ OD change. At least one power source provides the necessary energy to perform this process.

In an embodiment, an Integrated Eyewear has a physical on/off switch or function.

In another embodiment, removing a power source, e.g., a rechargeable battery, turns off an Integrated Eyewear, and placing a power source with or into an Integrated Eyewear automatically turns on the eyewear.

Many kinds of commands can be used as inputs to initiate a DFZ State Change Process.

They comprise at least one of: (1) physical movement of an Integrated Eyewear via head movement, (2) tilted or rotated position of an Integrated Eyewear via tilted or rotated head posture relative to a normally upright head posture, e.g., head tilted down, (3) physical movement or position of a person's eye(s), e.g., looking down, up or to the periphery, (3) touch, tap, press or use finger(s) to otherwise cause an Integrated Eyewear to move, (4) use facial muscles to move an Integrated Eyewear, e.g., a cheek or nose movement, (5) touch, tap, slide, press or using finger(s) to otherwise engage with a touch sensor, (6) use voice commands, e.g., voicing “mag on” or “mag off”, and (7) using an external device that is communicatively connected to any signal receiver of an Integrated Eyewear in order to command at least one ACS, e.g., use an electronic phone, electronic watch, electronic band or ring, or another wearable device to command the Integrated Eyewear via a Bluetooth connection.

An OWF can move into and out of a reservoir by at least one of: (1) a separate or separable EM-actuator 630 pushes, presses, pulls, compresses, expands, twists, squeezes, pinches a reservoir or otherwise change a reservoir's internal volume, the separate or separable EM-actuator(s) can be physically outside of, inside of and/or on the surface of a reservoir, and (2) the reservoir changes internal volume, e.g., compresses, expands, twists, squeezes and pinches, with an integrated actuator, i.e., the reservoir and the actuator combine to form one integrated component, such that removing all components of the actuator would cause the remaining components to unable to function or malfunction as a reservoir for the OWF.

In one embodiment, an actuator comprises one or more smart materials.

A smart material (also called responsive material) has with one or more mechanical properties that can be changed in a controlled fashion using one or more stimuli, such as an electric or magnetic field, stress, moisture, light, temperature, pH, or chemical compounds. Examples comprise of electroactive polymers (EAPs) and magnetic shape memory materials.

In some embodiments, a reservoir comprise at least one of a standalone reservoir, sealed tubing, and sealed cavity (ies) inside of or attached to an Integrated Eyewear.

In certain embodiments, an OWF comprise a smart material. Such OWF itself can move when under one or more stimuli, e.g., electric or magnetic field.

Examples of EM-actuators comprise pumps, rotary actuators, linear actuators, e.g., piezoelectric actuator.

Examples of pumps comprise centrifugal pumps, positive-displacement pumps and axial-flow pumps.

FIG. 7 700 is an example schematic of a manual-mechanically actuatable DFL 710 with one or more manual-mechanical (i.e., manually operated) actuators (“MM-actuators”) 730 and one or more standalone reservoirs 720 inside, on or otherwise attached to an Integrated Eyewear frame, preferably inside, on or otherwise attached to one or more frame temples 760.

In another embodiment, a reservoir comprised of sealed tubing and/or sealed cavity (ies), instead of a standalone reservoir, is used to store and carry (i.e., transport) an OWF.

In one embodiment, a reservoir with at least one OWF inside is fluidically connected 740 to a DFL 710 which comprises a DFZ 770. An MM-actuator 730 actuates a reservoir 720. An MM-actuator can be at least mechanically connected 750, preferably physically connected, to a reservoir 720. An MM-actuator is inside, on, attached to or otherwise physically integrated with an Integrated Eyewear frame, preferably with one or more frame temples.

A manual-mechanical movement of a MM-actuator caused by an external stimulus, e.g., externally applied force from a user's finger(s), acts on and changes the internal volume of a reservoir, which moves an OWF out of or into the reservoir, and which moves the OWF into or out of a DFL. The fluidic movement produces d-Rx ON, d-Rx OFF or a DFZ OD change in one or more DFZs.

Examples of a MM-actuator comprise a linear motion mechanism (e.g., slider, plunger, syringe, telescoping mechanism), a rotary motion mechanism (e.g., screw pump, screw press), a press mechanism (e.g., linear press, click button), a toggle mechanism, any other mechanical force actuation mechanism, or any combination thereof.

In some embodiments, the weight of an actuator is an important consideration for the user's acceptance of an Integrated Eyewear. The weight of an actuator comprises the weights of all components necessary for its actuation function, excluding the following: an Integrated Eyewear's frame (or sections thereof), power source, Input/Output (“I/O”) wiring to the actuator, any EC that only provides I/O commands and/or power to the actuator. For the avoidance of doubt, any EC or a driver circuit embedded with the actuator that dictates the mechanism by which the actuator functions, is a part of the weight of the actuator. An actuator weighs less than 20.0 grams, preferably less than 15.0 grams, more preferably less than 10.0 grams, and even more preferably less than 6.0 grams.

In some embodiments, an EM-actuator is capable of actuating with a maximum force, without stalling and without externally added mechanical advantage (e.g., without use of lever or pulleys), of between 0.01 Newton (“N”) and 6.00 N, preferably between 0.04 N and 4.00 N, more preferably between 0.06 N and 3.00 N.

In other embodiments, an EM-actuator is capable of actuating with a maximum torque, without stalling and without externally added mechanical advantage, of between 0.01 Newton-centimeter (“N-cm”) and 6.00 N-cm, preferably between 0.04 N-cm and 4.00 N-cm, more preferably between 0.06 N-cm and 3.00 N-cm.

In some embodiments, an EM-actuator's max force to weight ratio is less than 5.0 N/gram. Max force for this metric is defined as the maximum force an EM-actuator is capable of actuating, without stalling and without mechanical advantage.

In other embodiments, an EM-actuator's max torque to weight ratio is less than 5.0 N-cm/gram. Max torque for this metric is defined as the maximum torque an EM-actuator is capable of actuating, without stalling and without mechanical advantage.

In some embodiments, an actuator moves a volume of an OWF into or out of one or more DFLs. This volume is less than 4000 micro liters (“μL”), preferably less than 2000 μL, more preferably less than 1000 μL, even more preferably less than 500 μL, furthermore preferably less than 250 μL, and yet more preferably less than 100 μL.

In one embodiment, when a DFZ produces the maximum d-Rx, the maximum deflection (i.e., displacement) of any point on an FOPL's optical surface in a DFZ is less than 4.5 mm, preferably less than 3.0 mm, more preferably less than 2.0 mm, and even more preferably less than 1.0 mm. This max deflection is measured from the same point (i.e., location) on the FOPL's optical surface when the DFZ produces a zero or substantially zero d-Rx, i.e., FOPL in a zero- or substantially zero-displacement reference state.

The minimum thickness at any point on a FOPL in a DFZ is at least 10 micron, preferably at least 40 micron, more preferably at least 90 micron, even more preferably at least 190 micron, yet more preferably at least 390 micron, and furthermore preferably at least 790 micron.

The magnitude of the change in the geometric surface area of an FOPL in a DFZ, during DFZ activation, DFZ deactivation or DFZ OD change, is less than 15.0%, preferably less than 7.5%, more preferably less than 3.0%, and even more preferably less than 1.0%. The reference (i.e., denominator) value in the percentage calculation is the geometric surface area of the FOPL in the DFZ, with the DFZ producing a zero or substantially zero diopter of d-Rx. This (these) limitation(s) on an FOPL's surface area change ensures an FOPL's deformations are elastic in a DFZ.

A high optical clarity of a DFL is important. This high optical clarity comprise low visibility (ies) of interface(s) between a solid material and liquid OWF(s).

A low visibility of an interface can be achieved by limiting the mismatch between the refractive indices of two optical materials that form the interface. This method is called refractive index matching (“RI Matching”).

In some embodiments, to achieve a low visibility of one or more solid-liquid interfaces between an SCF and an OWF through RI Matching, the magnitude of the difference between the average refractive index of an SCF and the average refractive index of an OWF when tested at 25° C. is less than 0.20, preferably less than 0.10, more preferably less than 0.05, even more preferably less than 0.03 and yet more preferably less than 0.02. Preferably, the magnitude of the difference between the refractive index of an SCF and the refractive index of an OWF when measured at an incident light wavelength of 550 nm and at 25° C. is less than 0.20, preferably less than 0.10, more preferably less than 0.05, even more preferably less than 0.03 and yet more preferably less than 0.02.

In one or more embodiments, to achieve a low visibility of one or more solid-liquid interfaces between an FOPL and an OWF through RI Matching, the magnitude of the difference between the average refractive index of an FOPL and the average refractive index of an OWF when tested at 25° C. is less than 0.30, preferably less than 0.20, more preferably less than 0.10, even more preferably less than 0.05, and further preferably less than 0.03. Preferably, the magnitude of the difference between the refractive index of an FOPL and the refractive index of an OWF when measured at an incident light wavelength of 550 nm and at 25° C. is less than 0.30, preferably less than 0.20, more preferably less than 0.10, even more preferably less than 0.05 and yet more preferably less than 0.03.

In one or more embodiments, to achieve a low visibility of one or more solid-liquid interfaces between an RFL and an OWF through RI Matching, the magnitude of the difference between the average refractive index of an RFL and the average refractive index of an OWF when tested at 25° C. is less than 0.30, preferably less than 0.20, more preferably less than 0.10, even more preferably less than 0.05, and further preferably less than 0.03. Preferably, the magnitude of the difference between the refractive index of an RFL and the refractive index of an OWF when measured at an incident light wavelength of 550 nm and at 25° C. is less than 0.30, preferably less than 0.20, more preferably less than 0.10, even more preferably less than 0.05 and yet more preferably less than 0.03.

In one or more embodiments, to achieve a low visibility of one or more solid-liquid interfaces of an optical adhesive (also called optical, solid, adhesive material) in an optical area of a DFL and an OWF through RI Matching, the magnitude of the difference between the average refractive index of the optical adhesive and the average refractive index of an OWF when tested at 25° C. is less than 0.30, preferably less than 0.20, more preferably less than 0.10, even more preferably less than 0.05, and further preferably less than 0.03. Preferably, the magnitude of the difference between the refractive index of an optical adhesive and the refractive index of an OWF when measured at an incident light wavelength of 550 nm and at 25° C. is less than 0.30, preferably less than 0.20, more preferably less than 0.10, even more preferably less than 0.05 and yet more preferably less than 0.03.

An average refractive index of a material is calculated as the arithmetic average of the set of refractive indices that correspond to incident visible light wavelengths from 400 nm to 700 nm in 1-nm resolution.

The SCF (equivalently, an SCF feature of a single component comprising the SCF feature and at least one other feature) comprises at least one void, i.e., cavity. The thickness at or substantially at the perimeter of the at least one void in the SCF is less than 2.50 mm, preferably less than 1.50 mm, more preferably less than 1.00 mm, even more preferably less than 0.75 mm. The at least one void in the SCF is one of several elements of a DFZ. A geometrically thinner solid-liquid interface also helps to achieve a low visibility of such interface.

The total thickness of a DFL at the optical center for distance vision and not comprising a hyperopia corrective prescription, is less than 5.00 mm, preferably less than 4.00 mm, more preferably less than 3.00 mm and even more preferably less than 2.75 mm.

The total thickness of a DFL at the optical center for distance vision and comprising a hyperopia corrective prescription, is less than 7.00 mm, preferably less than 5.00 mm, more preferably less than 4.00 mm and even more preferably less than 3.75 mm.

The thickness of an RFL at its optical center is between 0.3 mm and 6.5 mm.

The thickness of an IPS is between 0.1 mm and 6.5 mm.

The thickness of an SCF is between 0.3 mm and 6.5 mm.

The thickness of a FOPL is less than 3.0 mm, preferably less than 2.0 mm, more preferably less than 1.2 mm.

In other embodiments, one or more anti-reflective coatings exist on a solid material side of a solid-liquid interface in order to achieve a low visibility of such interface(s).

In some embodiments, one or more anti-reflective coatings exist on a solid material side of a solid-air interface in order to achieve a low visibility of such interface(s).

In one or more embodiments, a combination of (1) RI Matching a solid material and an OWF, and (2) having one or more anti-reflective coatings on a solid material side of a solid-liquid interface with an OWF, are used to achieve a low visibility of the one or more solid-liquid interfaces.

The dynamic viscosity of an OWF is an important metric, because (1) an actuator must overcome the resistance to movement of an OWF due to its dynamic viscosity in order to move an OWF into and out of a DFL, and (2) dynamic viscosity of an OWF can vary greatly, sometimes by several orders of magnitude, depending on material composition(s) of an OWF. For example, when tested at 25° C., the dynamic viscosity of water is 1 centipoise (cP), of kerosene is about 10 cP, of maple syrup can be 150 cP, of glycerin can be 1000 cP, of molasses can be 10000 cP.

In one or more embodiments, the dynamic viscosity of an OWF when tested at 25° C. is less than 2500 cP, preferably less than 200 cP, more preferably less than 100 cP and even more preferably less than 60 cP.

The liquid-to-solid phase transition temperature (“freezing point”) of an OWF, at 1 atm pressure, is less than 5° C., preferably less than 0° C., more preferably less than −5° C., and even more preferably less than −10° C.

The boiling point of an OWF, at 1 atm pressure, is more than 35° C., preferably more than 50° C., more preferably more than 65° C., and even more preferably more than 85° C.

An OWF is a low haze and low color, transmissive optical fluid capable of transmitting visible light through it with minimal attenuation and scattering.

Low haze of an optical material is defined as the material having a less than 7.0% haze, as measured using the ASTM D1003-21 standard, measured with the material having a geometric pathlength of 1 mm with light in transmission. To control the geometric pathlength of a liquid: place the liquid in a high clarity glass cuvette with a 1 mm geometric pathlength of light in transmission.

Low color of an optical material is defined as it having a chroma of less than 20.0 and a lightness of more than 80.0 in the 1976 CIELCh color space.

Color, comprised of lightness, chroma and hue, of a visible light transmissive material is measured and calculated using the transmission spectrum of the material from 380 nm to 700 nm in 1-nm resolution (scanned by a photospectrometer), the 1976 CIELCh color space or the 1976 CIELAB color space, CIE D65 illuminant, the 2-degree Standard Observer, with the material having a geometric pathlength of 1 mm with visible light in transmission. Visible light transmission (“VLT”) and visible light itself are from 380 nm to 700 nm. To control the geometric pathlength of a liquid: place the liquid in a high clarity glass cuvette with a 1 mm geometric pathlength of light in transmission.

The difference between two colors, i.e., color difference,

$$Δ {E}_{ab}^{*} ,$$

using the 1976 CIELAB color space with (L₁*, a₁*, b₁*) representing one color and (L₂*, a₂*, b₂*) representing the other color, is calculated using the well-known color difference formula in Equation 1:

$$Δ {E}_{ab}^{*} = \sqrt{{( {L}_{2}^{*} - {L}_{1}^{*} )}^{2} + {( {a}_{2}^{*} - {a}_{1}^{*} )}^{2} + {( {b}_{2}^{*} - {b}_{1}^{*} )}^{2}} \qquad Equation 1$$

In some examples, an OWF comprises at least two of the following: (1) superior lightfastness, (2) superior lightfastness with chemical additives, e.g., UV stabilizers or absorbers, (3) superior lightfastness while reside inside a DFL with a RFL blocking at least 90% of ultraviolet light (UV) totaled between 300 nm and 380 nm, and (4) superior lightfastness while reside inside an opaque structure, e.g., the frame of an Integrated Eyewear or a reservoir.

In other examples, an optical, solid, adhesive material comprises at least one of the following: (1) superior lightfastness, (2) superior lightfastness with chemical additives, e.g., UV stabilizers or absorbers, and (3) superior lightfastness while reside optically behind an RFL that blocks at least 90% of ultraviolet light (UV) totaled between 300 nm and 380 nm.

Superior lightfastness of an optical material is defined as the material comprising (1) low haze (as defined above) after 200 hours of continuous exposure to direct electromagnetic waves between 300 nm and 400 nm in wavelength, with an intensity of 42 watt per square meter (W/m²) received by the material, with the immediate ambient environment controlled at 25° C. and 30% relative humidity (“Light Exposure Test”), and (2) a color difference,

$$Δ {E}_{ab}^{*} ,$$

of less than 20.0 before and after Light Exposure Test, i.e.,

$$Δ {E}_{ab}^{*}$$

is computed with the material's first color measured and calculated immediately before Light Exposure Test, and its second color measured and calculated immediately after Light Exposure Test.

The acceptable material stability of a material that interfaces with, i.e., in contact with, one or more other materials is crucial. The acceptable material stability of a material that interfaces with one or more other materials is tested immediately before (“Before-Contact Test”) and after (“After-Contact Test”) the material came in constant contact with the one or more other materials for a continuous duration of 100 days at an ambient temperature of 25° C., relative humidity of 30% and pressure of 1 atm.

The acceptable material stability of a solid, non-adhesive material in contact with one or more other materials, means the solid, non-adhesive material (1) comprises low crazing and low surface corrosion at Before-Contact Test and After-Contact Test, and (2) allows only a small change in each of its yield strength, Young's modulus, and volume from Before-Contact Test to After-Contact Test.

The acceptable material stability of an optical, solid, non-adhesive material in contact with one or more other materials, means the optical, solid, non-adhesive material:
(1) comprises, at Before-Contact Test and After-Contact Test, at least one of (i) low haze, and (ii) superior lightfastness,
(2) comprises all the above defined characteristics of the acceptable material stability of a solid, non-adhesive material, and
(3) allows only a small change in each of its material color and average refractive index (tested at 25° C.) from a Before-Contact Test to an After-Contact Test.

The acceptable material stability of a solid, adhesive material (after a 48-hour cure period) in contact with one or more other materials, means the solid, adhesive material allows only a small change in each of its volume and shear strength from a Before-Contact Test to an After-Contact Test.

The acceptable material stability of an optical, solid, adhesive material (after a 48-hour cure period) in contact with one or more other materials, means the optical, solid, adhesive material:
(1) comprises, at Before-Contact Test and After-Contact Test, at least one of (i) low haze and low color, and (ii) superior lightfastness,
(2) comprises all the above defined characteristics of the acceptable material stability of a solid, adhesive material after a 48-hour cure, and
(3) allows only a small change in its average refractive index (tested at 25° C.) from Before-Contact Test to After-Contact Test.

The acceptable material stability of an OWF in contact with one or more other materials, means the OWF:
(1) comprises, at Before-Contact Test and After-Contact Test, at least one of (i) low haze and low color, and (ii) superior lightfastness, and
(2) allows only a small change in each of its dynamic viscosity (tested at 25° C.), volume, average refractive index (tested at 25° C.), freezing point (tested at 1 atm pressure) and boiling point (tested at 1 atm pressure) from a Before-Contact Test to an After-Contact Test.

Specifically, the low crazing of a solid material does not comprise any surface, substantially surface, or near surface defect longer than 0.17 mm, e.g., crack, scratch, stain, cavity, gash, bump, protrusion, pit and/or chip, at Before-Contact Test and After-Contact Test.

Specifically, the low surface corrosion of a solid material comprise no more than three surface defects longer than 0.10 mm, e.g., crack, scratch, stain, cavity, gash, bump, protrusion, pit and/or chip, at Before-Contact Test and After-Contact Test.

Specifically, a small change in the yield strength of a solid material comprises a less than 30% (positive or negative, i.e., increase or decrease) change in the material's yield strength from Before-Contact Test to After-Contact Test. The percentage criterion is calculated using the yield strength at Before-Contact Test as the reference value, i.e., denominator value.

Specifically, a small change in the Young's modulus of a solid material comprises a less than 30% (positive or negative) change in the material's Young's modulus from Before-Contact Test to After-Contact Test. The percentage criterion is calculated using the Young's modulus at Before-Contact Test as the reference value.

Specifically, a small change in the volume of a material comprises a less than 30% (positive or negative) change in the material's volume from Before-Contact Test to After-Contact Test. The percentage criterion is calculated using the volume at Before-Contact Test as the reference value. For example, swelling is a type of positive change in the material's volume; shrinkage is a type of negative change in the material's volume.

Specifically, a small change in the color of an optical material comprises a small color difference, ΔE_{ab}*), of less than 20.0 in the material's color from Before-Contact Test to After-Contact Test. I.e., ΔE_{ab}*, is computed with the material's first color measured and calculated at Before-Contact Test, and the material's second color measured and calculated at After-Contact Test.

Specifically, a small change in the average refractive index (tested at 25° C.) of an optical material comprises a positive or negative change of less than 0.105 in the material's average refractive index from Before-Contact Test to After-Contact Test.

Specifically, a small change in the shear strength of a solid, adhesive material comprises a less than 60% (positive or negative) change in the shear strength of the material from Before-Contact Test to After-Contact Test. The percentage criterion is calculated using the shear strength at Before-Contact Test as the reference value. Shear strength is tested per ISO 4587 standard at an ambient condition of 22° C. and 55% relative humidity.

Specifically, a small change in the dynamic viscosity of a fluid comprises a less than 50% (positive or negative) change in the material's dynamic viscosity (tested at 25° C.) from Before-Contact Test to After-Contact Test. The percentage criterion is calculated using the dynamic viscosity at Before-Contact Test as the reference value, i.e., denominator value.

Specifically, a small change in the freezing point of a fluid comprises a positive or negative change, i.e., increase or decrease, of less than 15° C. in the material's freezing point (tested at 1 atm pressure) from Before-Contact Test to After-Contact Test.

Specifically, a small change in the boiling point of a fluid comprises a positive or negative change of less than 15° C. in the material's boiling point (tested at 1 atm pressure) from Before-Contact Test to After-Contact Test.

For the purpose of engineering or maintaining acceptable material stability: (1) an IPS comprises at least one solid, non-adhesive material, with the IPS as a separate component, or with the IPS as a feature of a single component comprising two or more features, (2) an RFL comprises at least one optical, solid, non-adhesive material, with the RFL as a separate component, or with the RFL as a feature of a single component comprising two or more features, (3) an SCF comprises at least one optical, solid, non-adhesive material, with the SCF as a separate component, or with the SCF as a feature of a single component comprising two or more features, and (4) an FOPL comprises at least one optical, solid, non-adhesive material, with the FOPL as a separate component, or with the FOPL as a feature of a single component comprising two or more features.

In one embodiment, an Integrated Eyewear comprises one or more reservoir(s), which transports or is capable of transporting one or more OWFs. Furthermore, the one or more of reservoir(s) comprise at least one solid, non-adhesive material, with each reservoir as a separate component, or with each reservoir as a feature of a single component comprising two or more features. Moreover, the one or more reservoir(s) and the one or more OWFs each maintains its own acceptable material stability.

In another embodiment, an Integrated Eyewear comprises one or more hollow tube(s), which carries or is capable of carrying one or more OWFs. Furthermore, the one or more of hollow tube(s) comprise at least one solid, non-adhesive material, with each tube as a separate component or as a feature of a single component comprising two or more features. Moreover, the one or more hollow tubes(s) and the one or more OWFs each maintains its own acceptable material stability.

One or more OWFs interface with one or more SCFs, with the one or more OWFs and the one or more SCFs each maintaining its own acceptable material stability.

One or more OWFs interface with one or more RFLs, with the one or more OWFs and the one or more RFLs each maintaining its own acceptable material stability.

One or more OWFs interface with one or more IPSs, with the one or more OWFs and the one or more IPSs each maintaining its own acceptable material stability.

In one embodiment, one or more OWFs interface with one or more FOPLs, with the one or more OWFs and the one or more FOPLs each maintaining its own acceptable material stability.

In one embodiment, one or more OWFs interface with one or more optical, solid, adhesive materials, with the one or more OWFs and the one or more optical, solid, adhesive materials each maintaining its own acceptable material stability.

In another embodiment, one or more OWFs interface with one or more solid, adhesive materials, with the one or more OWFs and the one or more solid, adhesive materials each maintaining its own acceptable material stability.

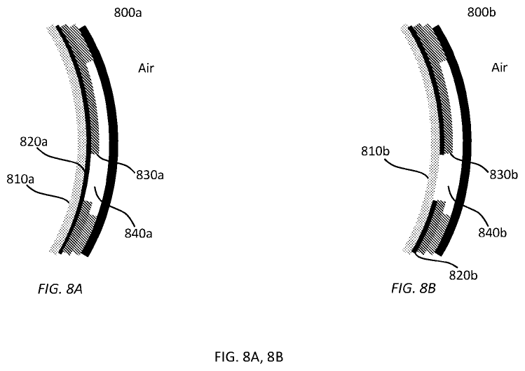

In some embodiments, (e.g., FIG. 8A 800a, an example construction of a DFL, viewed at the cross-section of a DFZ), one or more optical, solid, adhesive materials 820a adhere or bond one or more FOPLs 810a with one or more SCFs 830a, with one or more OWFs 840a (which reside in one or more cavities in a DFL, e.g., one or more of OIC and cavity in a DFZ) interface with (1) the one or more optical, solid, adhesive materials 820a, and (2) the one or more SCFs 830a. It follows, (1) the one or more SCFs 830a contact (i.e., interface) with the one or more OWFs 840a, and each material maintains its own acceptable material stability, (2) the one or more SCFs 830a contact with the one or more optical, solid, adhesive materials 820a, and each material maintains its own acceptable material stability, (3) the one or more OWFs 840a contact with the one or more optical, solid, adhesive materials 820a, and each material maintains its own acceptable material stability, and (4) the one or more FOPLs 810a contact with the one or more optical, solid, adhesive materials 820a, and each material maintains its own acceptable material stability.

In other embodiments, (e.g., FIG. 8B 800b, an example construction of a DFL, viewed at the cross-section of a DFZ), one or more optical, solid, adhesive materials 820b adhere or bond one or more FOPLs 810b with one or more SCFs 830b, with one or more OWFs 840b (which reside in one or more cavities in a DFL, e.g., one or more of OIC and cavity in a DFZ) interface with (1) the one or more optical, solid, adhesive materials 820b, (2) the one or more SCFs 830b, and (3) the one or more FOPLs 810b. It follows, (1) the one or more SCFs 830b contact with the one or more OWFs 840b, and each material maintains its own acceptable material stability, (2) the one or more SCFs 830b contact with the one or more optical, solid, adhesive materials 820b, and each material maintains its own acceptable material stability, (3) the one or more OWFs 840b contact with the one or more optical, solid, adhesive materials 820b, and each material maintains its own acceptable material stability, (4) the one or more FOPLs 810b contact with the one or more optical, solid, adhesive materials 820b, and each material maintains its own acceptable material stability, and (5) the one or more FOPLs 810b contact with the one or more OWFs 840b, and each material maintains its own acceptable material stability.

In one embodiment,
(1) one or more SCFs and one or more FOPLs are bonded together, such as using thermal bonding, bonding using corona or plasma surface treatments, without using one or more intermediary optical, solid, adhesive materials, or
(2) one or more SCF features and one or more FOPL features are two or more features of a single component,
   and one or more OWFs, which reside in one or more created cavities in a DFL, e.g., one or more of OIC and cavity in a DFZ, interface with (1) the one or more SCFs, equivalently the one or more SCF features of a single component, and (2) the one or more FOPLs, equivalently the one or more FOPL features of a single component. It follows, (1) the one or more SCFs contact with the one or more OWFs and each material maintains its own acceptable material stability, and (2) the one or more FOPLs contact with the one or more OWFs and each material maintains its own acceptable material stability.

In some embodiments, one or more solid, adhesive materials adhere or bond one or more IPSs with one or more RFLs, with one or more OWFs (which reside in one or more created cavities in a DFL, e.g., one or more of OIC and cavity in a DFZ) interface with (1) the one or more solid, adhesive materials, (2) the one or more IPSs, and (3) the one or more RFLs. Consequently, (1) the one or more RFLs contact with the one or more OWFs, and each material maintains its own acceptable material stability, (2) the one or more IPSs contact with the one or more OWFs, and each material maintains its own acceptable material stability, and (3) the one or more OWFs contact with the one or more solid, adhesive materials, and each material maintains its own acceptable material stability.

In one embodiment, in order for an OWF and the one or more solid materials the OWF contacts with to each maintain its own acceptable material stability, at 25° C., 1 atm and a constant light exposure of 50 W/m² received by the contact interface(s) from a CIE F7 light source, the OWF comprises a diffusion coefficient of less than 30.0×10−5 cm²/sec, preferably less than 3.0×10−5 cm²/sec, even more preferably less than 0.3×10−5 cm²/sec.

In another embodiment, in order for an OWF and a solid material the OWF contacts with to each maintain its own acceptable material stability, at 25° C., 1 atm and a constant light exposure of 50 W/m² received by the contact interface(s) from a CIE F7 light source, the solid material comprises a solubility in the OWF at less than 500 mg/L (mg of solid material in 1 liter of OWF), preferably less than 100 mg/L, even more preferably less than 30 mg/L.

In one embodiment, in order for an OWF and the one or more solid materials the OWF contacts with to each maintain its own acceptable material stability, at 25° C., 1 atm and a constant light exposure of 50 W/m² received by the contact interface(s) from a CIE F7 light source, the rate of reaction of the two materials is less than 100 mg/L/sec (mg of solid material in 1 liter of OWF), preferably less than 10 mg/L/sec, even more preferably less than 1 mg/L/sec, and furthermore preferably less than 0.1 mg/L/sec. All reaction rate limits comprise 0.0 mg/L/sec to indicate no reaction at the prescribed temperature, pressure and lighting conditions.

There are various material science or chemical methods to achieve the one or more of prescribed diffusion coefficient limitation(s), prescribed solubility limitation(s) and prescribed reaction rate limitation(s). The methods comprise at least one of: (1) an OWF comprise a majority of aliphatic molecules and only a minority of aromatic molecules, (2) the polarity of an OWF and the polarity of a solid at their interface are very different, i.e., have a difference of at least 2.0 in polarity index, (3) molecules do not have bonds that can be broken by UV and visible light exposure, and (4) a high activation energy requirement, i.e., a high barrier to a chemical reaction at the liquid-solid interface.

In one embodiment, an FOPL comprise one or more coatings on at least one of the FOPL's optical surfaces. Examples of such coatings comprise at least one of anti-abrasion coating, anti-reflective coating, adhesive coating, oleophobic coating, oleophilic coating, anti-fog coating, anti-saltwater coating, hydrophobic coating, hydrophilic coating, blue-light blocking coating, and coating that reduces the refractive index differential between the FOPL and at least one other material (e.g., air or an OWF) that the FOPL contacts.

In another embodiment, an RFL comprise one or more coatings on at least one of the RFL's optical surfaces. Examples of such coatings comprise at least one of anti-abrasion coating, anti-reflective coating, adhesive coating, oleophobic coating, oleophilic coating, anti-fog coating, anti-saltwater coating, hydrophobic coating, hydrophilic coating, blue-light blocking coating, and coating that reduces the refractive index differential between the RFL and at least one other material (e.g., air or an OWF) that the RFL contacts.

In one embodiment, an SCF comprise one or more coatings on at least one of the SCF's optical surfaces. Examples of such coatings comprise at least one of anti-abrasion coating, anti-reflective coating, adhesive coating, oleophobic coating, oleophilic coating, anti-fog coating, anti-saltwater coating, hydrophobic coating, hydrophilic coating, blue-light blocking coating, and coating that reduces the refractive index differential between the SCF and at least one other material (e.g., an OWF) that the SCF contacts.

In one embodiment, a coating that reduces the refractive index differential between two materials in contact comprise the coating's own average refractive index be between the two refractive indices of the two materials (in solid, liquid or gas state) that created the original interface. For example, an OWF with a refractive index of 1.48 interfaces with an SCF with a refractive index of 1.59. A coating on the SCF that reduces the refractive index differential of 0.11 has an average refractive index between 1.48 and 1.59, e.g., 1.53, and such coated SCF interfaces the OWF.

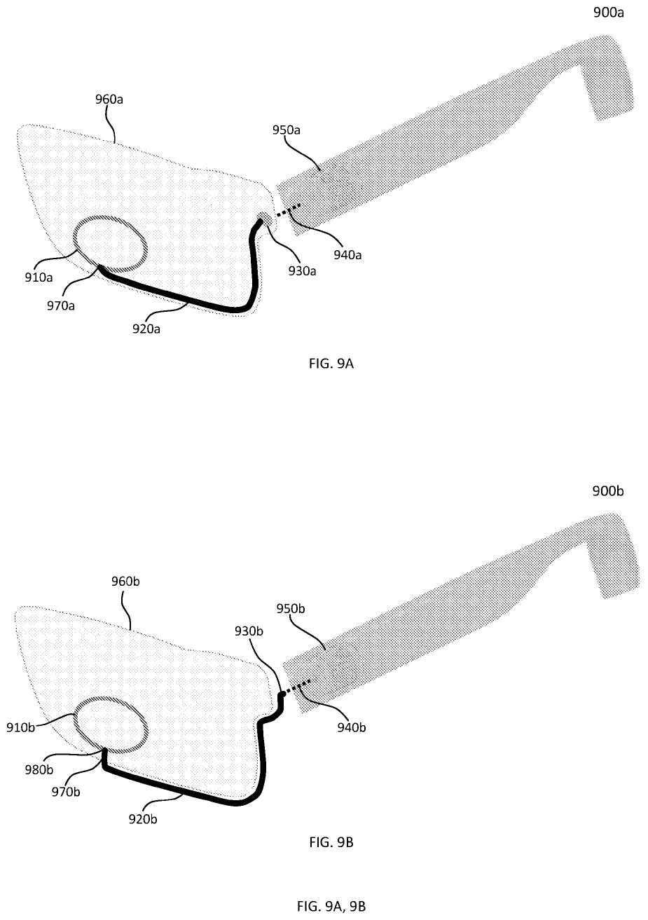

FIG. 9A 900a illustrates an embodiment of fluidic connections between a DFZ 910a, an NOC 920a, an opening 930a in a DFL 960a and a reservoir 950a. The NOC 920a is integrated with (i.e., not separable from) the DFL 960a, and the cavity comprises at least one OWF and it transports at least a portion of the at least one OWF into and out of the fluidically connected DFZ 910a at a connection point 970a inside the DFL 960a. The NOC, preferably located substantially or at least partially inside of the DFL, follows substantially along the top and/or bottom portion of the perimeter of the DFL 960a, with the bottom option being illustrated 920a. The NOC comprises one or more of: (1) is visible by peripheral vision, and/or (2) is partially or completely hidden by the frame of an Integrated Eyewear. The NOC also transports at least a portion of the at least one OWF into and out of the DFL via at least one opening 930a in the DFL. The at least one opening 930a is formed by creating at least one void in the DFL (e.g., by creating a void in at least one of an SCF, an FOPL, an IPS and an RFL) to allow the at least one OWF passage in and out of the DFL. The at least one opening is further fluidically connected 940a to at least one hollow structure, e.g., a reservoir 950a or a hollow tube, housing the at least one OWF. Preferably, the at least one hollow structure is external to an DFL, and is physically connected to, e.g., embedded inside, the frame of an Integrated Eyewear.

In the embodiment of FIG. 9A 900a, an OIC can replace an NOC. That is, FIG. 9A 900a also illustrates an embodiment of fluidic connections between a DFZ 910a, an OIC 920a, an opening 930a in a DFL 960a and a reservoir 950a. The OIC 920a is integrated with (i.e., not separable from) the DFL 960a, and the cavity comprises at least one OWF and it transports at least a portion of the at least one OWF into and out of the fluidically connected DFZ 910a at a connection point 970a inside the DFL 960a. The OIC, preferably located substantially or at least partially inside of the DFL, follows substantially along the top and/or bottom portion of the perimeter of the DFL 960a, with the bottom option being illustrated 920a. The OIC comprises one or more of: (1) is invisible or nearly invisible by peripheral vision, and/or (2) is partially or completely hidden by the frame of an Integrated Eyewear. The OIC also transports at least a portion of the at least one OWF into and out of the DFL via at least one opening 930a in the DFL. The at least one opening 930a is formed by creating at least one void (i.e., inlet/outlet) in the DFL (e.g., by creating a void in at least one of an SCF, an FOPL, an IPS and an RFL) to allow the at least one OWF passage in and out of the DFL. The at least one opening is further fluidically connected 940a to at least one hollow structure, e.g., a reservoir 950a or a hollow tube, housing the at least one OWF. Preferably, the at least one hollow structure is external to an DFL, and is physically connected to, e.g., embedded inside, the frame of an Integrated Eyewear.

FIG. 9B 900b illustrates an embodiment of fluidic connections between a DFZ 910b, an SCTD 920b, an opening 970b in a DFL 960b and a reservoir 950b. The SCTD 920b is outside of and/or separable from the DFL 960b, and the conduit comprises at least one OWF and it transports at least a portion of the at least one OWF into and out of the fluidically connected DFZ 910b at a connection point 980b, inside the DFL 960b. The SCTD, preferably located substantially outside of the DFL, follows substantially along the top and/or bottom portion of the perimeter of the DFL 960b, with the bottom option being illustrated 920b. The SCTD comprises one or more of: (1) invisible or nearly invisible by peripheral vision, (2) partially or completely hidden by the frame of an Integrated Eyewear, and/or (3) designed to not appear as or designed to reduce its appearance as a conduit for better aesthetics. The SCTD further comprises one or more of: (1) the SCTD connects to the DFL at the lens' opening 970b (wherein the DFL's internal cavity, which fluidically connects the SCTD at opening 970b to the DFZ at 980b) comprise one or more of an OIC and/or an NOC, and (2) the SCTD passes through one or more openings 970b in the DFL (e.g., passes through the DFL's internal void between DFL's opening 970b and DFZ's connection point 980b or passes through a void in at least one of an IPS and an SCF), in order to directly transport the at least one OWF into and out of the DFZ 910b at point 980b. The at least one cavity (i.e., void) of the DFL (e.g., between 970b and 980b) is formed by creating at least one void through the border of the DFL, e.g., by creating a void in at least one of an IPS and an SCF. The at least one SCTD 920b 930b is further fluidically connected 940b to (or becomes or morphs to) at least one hollow structure, e.g., a reservoir 950b or a hollow tube, housing the at least one OWF. Preferably, the at least one hollow structure is external to an DFL, and is physically connected to, e.g., embedded inside, the frame of an Integrated Eyewear.

In a variant, the at least one hollow structure is a physical continuation of the at least one SCTD, i.e., a component comprising at least one SCTD feature and at least one reservoir feature.

In some embodiments, a DFL comprises an IPS.

In other embodiments, a DFL does not comprise any IPS. It should be noted that a DFL can be constructed without any IPS, and comprises at least one of a NOC, an OIC and an SCTD to hold and/or transport at least one OWF (at least partially thereof) into and out of at least one DFZ.

In some embodiments, an RFL comprises a polarizer.

In other embodiments, an FOPL comprises a polarizer.

The material composition of an RFL (equivalently an RFL feature of a single component comprising the feature) comprises at least one of an optical polymer and an optical glass.

The material composition of an SCF (equivalently an SCF feature of a single component comprising the feature) comprises at least one of an optical polymer and an optical glass.

The material composition of an FOPL (equivalently an FOPL feature of a single component comprising the feature) comprise an optical polymer and an optical glass.

IPS (or equivalently an IPS feature of a single component comprising the feature) comprises any material with acceptable material stability in a DFL. Example suitable materials comprise at least one of polymer, glass, metal, ceramic, wood, fabric, composite material and combination thereof.

An example optical polymer material comprise at least one of polycarbonate, CR39, Trivex, polymethylmethacrylate (“PMMA”), polyamide (“nylon”), polyimide, polyurethane, polystyrene, triacetate cellulose (“TAC”), Hivex, polythiourethane, polyethylene, polyethylene terephthalate (“PET”), PET glycol (“PETG”), polyester, cyclic olefin polymers (“COP”), polyetherimide (“PEI”), polymethylpentene (“PMP”), polyether, polyvinyl, polymer-glass hybrid, derivatives thereof, bio-sourced derivatives thereof, any other type of thermosetting polymer, and any other type of thermoplastic.

An example optical glass material comprises at least one of borosilicate glass, quartz glass, crown glass, flint glass, soda-lime glass, calcium fluoride glass, chemically strengthened glass, aluminosilicate glass, polymer-glass hybrid, foldable glass and derivatives thereof.

The material composition of any elastomeric object, in which an OWF resides, can reside or contacts, e.g., a reservoir and hollow tubing, can be any elastomer material with acceptable material stability in contact with an OWF. Example suitable elastomer materials comprise at least one of the following: natural rubber, styrene butadiene, butyl, ethylene propylene, neoprene, nitrile, silicone, fluorocarbon, perfluorocarbon, fluoro silicone, perfluoro silicone, polyurethane, ethylene propylene diene terpolymer (“EPDM”), ethylene propylene, polyacrylate, synthetic rubber, polyethylene synthetic rubber, fluoro elastomer, perfluoro elastomer, per- and polyfluoroalkyl substances (“PFASs”), epichlorohydrin rubber, polysulfide, ethylene acrylic and derivatives thereof.

The material composition of an OWF can be any optical liquid, provided the material comprises: (1) acceptable material stability in contact with one or more components or features in a DFL, e.g., RFL, SCF and optical adhesive, (2) suitable native properties of the liquid itself, e.g., suitable dynamic viscosity, lightfastness, color, haze, freezing point, boiling point, and (3) suitable RI Matching with one or more optical components or features in a DFL the fluid contacts with, e.g., SCF, RFL, optical adhesive, FOPL. For example, an OWF can comprise one or more of aliphatic molecules, transparent light paraffin oil with at least a majority of aliphatic molecules, silicone oil, water, alcohol, turpentine, tetralin, glycerol, sodium iodide, glycol, decalin, sodium salicylate, methyl salicylate, salicylate, ethanol, saline, cymeme, butylphthalate, ethylphthalate, phthalate, zinc iodide, iodide, thiocyanate, cyclohexyl bromide, bromide, methylnaphthalene, chloronaphthalene, naphthalene, methylcylohexane, cyclohexane, hexane, methoxybenzene, benzene, methyl benzoate, benzoate, tetrachloroethylene, ethylene, tetrabromoethane, ethane, mineral oil, paraffin oil, naphthenic oil, aromatic oil, automotive oils, any derivatives thereof and any combination thereof.

The material composition(s) (or chemical composition(s)) of an optical adhesive are numerous. Some examples are epoxy, polyurethane, polyimide, silicone, rubber, cyanoacrylate, acrylic, any derivatives thereof and any combination thereof. There are also multiple physical forms of optical adhesive, for example, paste, liquid, film, tape and pellets. There are also multiple methods of adhesive application, for example, hot melt, reactive hot melt, reactive, thermosetting (e.g., single component, two component), pressure sensitive and via contact.

In one embodiment, an FOPL is created from one or more optical polymer sheets, films, wafers or layers that is (are) thermoformed, vacuum formed, pressed, molded or otherwise processed (i.e., shaped) to have a non-flat shape, prior to or during bonding the FOPL with an SCF while making a DFL.

During DFZ activation, DFZ deactivation and/or DFZ OD change, the d-Rx of each DFZ, for all DFZs in a DFL, has an average rate of change of at least 0.2 diopter per second, preferably at least 0.5 diopter per second, more preferably at least 1 diopter per second, even more preferably at least 2 diopters per second, and furthermore preferably at least 3 diopters per second.

During active operation of an actuator, e.g., DFZ activation, DFZ deactivation and/or DFZ OD change, the actuator's average noise (or sound) level, measured in open air, in decibels (“dB”), and measured at a distance of 10.0 mm away from the geometric center of the actuator, with the actuator housed inside an enclosed frame of an Integrated Eyewear, is less than 40.0 dB, preferably less than 25.0 dB, more preferably less than 15.0 dB, even more preferably less than 5.0 dB, and furthermore preferably less than 2.5 dB.

In some embodiments, in order to achieve a low, average noise level during the active operation of an actuator as stated above, an integrated eyewear comprises one or more of: (1) one or more low noise actuators, (2) an actuator operating in low noise mode, (3) the integrated eyewear's frame and frame components do not (or do not substantially) amplify the actuator(s)'s noise, (4) passive noise reduction (or cancellation), and (5) active noise reduction (or cancellation). Examples of a low noise actuator comprise one or more of: an actuator comprising a quiet smart material (e.g., EAPs and shape memory materials), an actuator having low noise design and well-controlled manufacturing tolerances, and/or the use of lubricants to minimize friction noise between an actuator's various components in contact. Examples of an actuator operating in low noise mode comprise one or more of: low actuation speed, low actuation acceleration, low actuation jerk and low actuation jounce. Examples of frame and frame components not amplifying an actuator's noise comprise one or more of: (1) low or no audible vibration of the frame and frame components caused by an actuator's active operation, and (2) frame and frame components do not audibly resonate during an actuator's active operation. Examples of passive noise reduction comprise one or more of: the actuator, frame and/or frame components use(s) sound dampening/deadening materials, e.g., soft foam and soft silicone padding. Examples of active noise reduction comprise an active sound generator producing noise-reduction soundwaves, for example noise-inverted soundwaves.

In one embodiment of an Integrated Eyewear, one EM- or MM-actuator can only actuate one or more DFZs of only one DFL. Therefore, two EM- or MM-actuators are needed to actuate the DFZs of two DFLs.

In another embodiment of an Integrated Eyewear, only one of an EM-actuator or an MM-actuator is needed to actuate two or more DFZs of at least two DFLs.

In one embodiment, at least one of an RFL and an FOPL of a DFL comprises at least one of (1) one or more optical coatings, and (2) one or more dyes in order to attenuate the transmission spectrum of the DFL, such that the arithmetic average transmission between 400 nm and 440 nm (inclusive) is at least 5% less (absolute) (preferably at least 10% less (absolute), more preferably at least 20% less (absolute)), than the arithmetic average transmission between 500 nm and 530 nm (inclusive). A DFL with this transmission spectral characteristic is called a Blue Cut DFL.

The one or more optical coatings in the above embodiment of a Blue Cut DFL comprises at least one of following coatings modified to reflect light between 400 nm and 440 nm (inclusive): (1) a multilayer interference coating, (2) an anti-reflective coating, and (3) a thin film coating comprising at least one of metallic materials and/or metal atoms. Such a coating can be applied onto or into one or more optical surfaces of at least one of an RFL and an FOPL. Preferably, such coated optical surface does not contact an OWF.

The one or more dyes in one embodiment of a Blue Cut DFL (1) is organic, (2) is yellow, yellow-green or green in color when dissolved in a solvent and lit by daylight, and (3) have a higher arithmetically-averaged absorbance over the light wavelength region between 400 nm and 440 nm (inclusive) than that over the light wavelength region between 500 nm and 530 nm (inclusive). The one or more dyes are at least one of (1) evenly dissolved in the plastic material of at least one of an RFL and an FOPL, (2) evenly dissolved in one or more solvents that coat at least one optical surface of at least one of an RFL and an FOPL, and/or (3) evenly dissolved in one or more solvents surrounding at least one optical surface of at least one of an RFL and an FOPL, in order for the dye(s) to diffuse into the at least one optical surface during its tinting process. One example dye to create a Blue Cut DFL is a quinoline called Disperse Yellow 64. A dye has a concentration of between 0.1 mg to 10.0 g per 1 kg of solvent or plastic material.

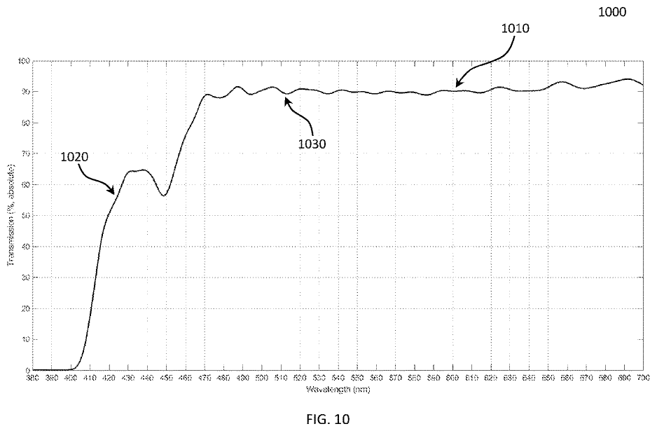

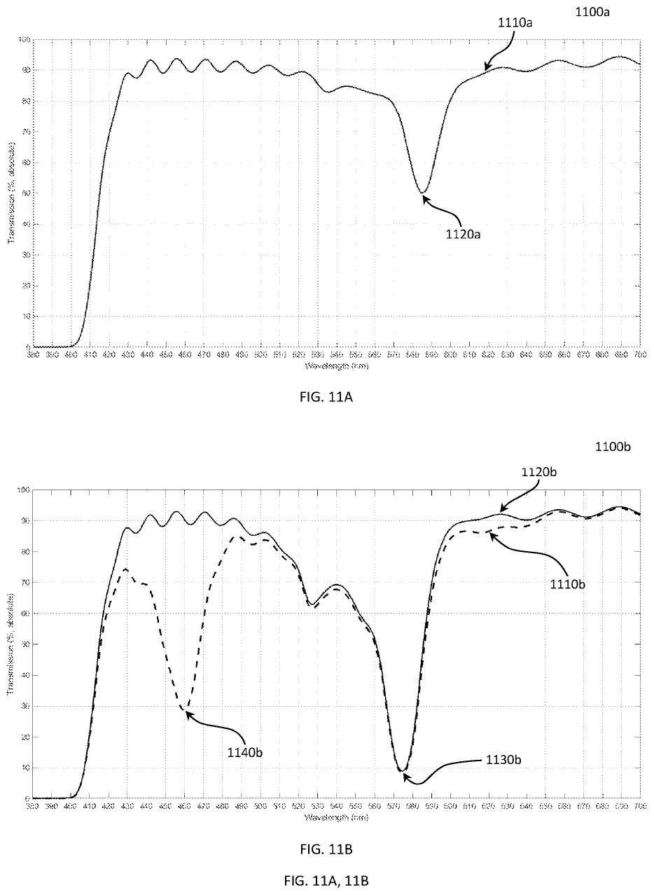

For one embodiment of a Blue Cut DFL, the transmission spectrum 1010 of the DFL is shown in FIG. 10 1000. The transmission spectrum shows the spectral effects of having Disperse Yellow 64 dispersed in an RFL comprising an UV-blocking polymer material, e.g., polycarbonate. The arithmetically-averaged transmission attenuation between 400 nm and 440 nm 1020 is at least 10% (absolute), preferably at least 20% (absolute), more than that between 500 nm and 530 nm 1030.

In another embodiment, an RFL of a DFL comprises one or more organic dyes to attenuate the transmission spectrum of the DFL, such that the minimum light transmission between 560 nm and 615 nm (inclusive) is at least 7.5% less (absolute), preferably at least 15.0% less (absolute), more preferably at least 25.0% less (absolute), than at least one of (preferably both of) (1) the maximum transmission between 500 nm and 559 nm (inclusive), and (2) the maximum transmission between 616 nm and 680 nm (inclusive). A DFL with this transmission spectral characteristic is called a color enhancing DFL (“Color Enhancing DFL”), which increases at least one of (1) the color difference between a red and a green color and (2) the chroma of at least one of a red and a green color. The one or more organic dyes are called Color Enhancing Dye(s) (“CED(s)”).

The one or more CEDs in the above embodiment of a Color Enhancing DFL is (are) (1) organic, and (2) cyan, blue, purple or reddish in color when dissolved in a solvent, e.g., DCM. The one or more dyes are at least one of (1) evenly dissolved in the plastic material of at least one of an RFL and an FOPL, (2) evenly dissolved in one or more solvents that coat at least one optical surface of at least one of an RFL and an FOPL, and/or (3) evenly dissolved in one or more solvents, e.g., dye bath, surrounding at least one optical surface of at least one of an RFL and an FOPL, in order for the dye(s) to diffuse into the at least one optical surface during its tinting process. When the one or more dyes is incorporated into or onto the at least one of an RFL and an FOPL, between the wavelength region from 500 nm to 700 nm (inclusive), (1) the peak absorbance of the one or more dyes is between 560 nm and 615 nm (inclusive), and (2) the full width at half maximum (“FWHM”) of the absorbance of the one or more dyes is less than 60 nm, preferably less than 45 nm and more preferably less than 30 nm. Two example CEDs are ABS 574 and ABS 584 from Exciton (Luxottica Exciton, Lockbourne, Ohio). A CED has a concentration of between 0.1 mg to 10.0 g per 1 kg of solvent or plastic material. Preferably, the one or more organic dyes comprise at least one of (1) a cyanine or derivative, (2) a metalated dye or derivative, (3) a macrocycle or derivative. Furthermore, the one or more organic dyes have low to no visible fluorescence.

For one embodiment of a Color Enhancing DFL, the transmission spectrum 1110a of the DFL is shown in FIG. 11A 1100a. The transmission spectrum shows the spectral effects of having a CED, ABS 584 1120a, dispersed in an RFL comprising an UV-blocking polyurethane material, e.g., Trivex.

For a Color Enhancing DFL, the white point of the DFL is the color of the lens illuminated under (i.e., lit by) a selected illuminant. This lens white point is computed using the 1976 CIELAB color space, 2-degree Standard Observer, the transmission spectrum of the DFL from 380 nm to 700 nm in 1-nm resolution, and one illuminant selected from the set of four illuminants of (1) CIE D65, (2) CIE F7, (3) CIE F11, and (4) CIE LED-B4. Without careful color balancing or color tuning, the white point of the DFL would naturally (and undesirably) vary under different and separate illuminants—a color phenomenon called color inconstancy—as the different illuminants have noticeably different spectral power distributions, leading to different color production properties. The amount of color inconstancy of the Color Enhancing DFL is measured by calculating the color difference between the white point of the lens lit by one illuminant and that lit separately by another illuminant. Equation 2 is the governing formula for the color inconstancy of a Color Enhancing DFL lit separately by two different illuminants,

$$Color {Inconstancy}_{illuminants 1 , 2} = \sqrt{{( {L}_{i 2}^{*} - {L}_{i 1}^{*} )}^{2} + {( {a}_{i 2}^{*} - {a}_{i 1}^{*} )}^{2} + {( {b}_{i 2}^{*} - {b}_{i 1}^{*} )}^{2}} \qquad Equation 2$$

where

$$( {L}_{i 1}^{*} , {a}_{i 1}^{*} , {b}_{i 1}^{*} )$$

represents the wine point of the DFL lit by one illuminant, and

$$( {L}_{i 2}^{*} , {a}_{i 2}^{*} , {b}_{i 2}^{*} )$$

the white point of the DFL lit separately by another illuminant. As color inconstancy of the lens is undesirable, the transmission spectrum of the Color Enhancing DFL is further modified to specifically control (i.e., limit) the amount of color inconstancy, i.e., color tuning. However, the tradeoffs to the further spectral modifications comprise: (1) creating a more complex lens spectrum that is more difficult to manufacture, (2) incorporating at least one more colored material, e.g., dye and/or optical coating, into and/or onto the lens, and (3) creating a DFL with a slightly to noticeably lower lightness, i.e., darker DFL.

In an embodiment of a Color Enhancing DFL, the DFL additionally comprises one or more of: (1) incorporating at least one organic dye with the maximum absorbance at a visible light wavelength of less than 560 nm into and/or onto the DFL, and/or (2) incorporating at least one organic dye with the maximum absorbance at a visible light wavelength of more than 610 nm into and/or onto the DFL, as Color Inconstancy Control Dye(s) (“CICD(s)”) to specifically control the amount of color inconstancy in the DFL lit separately by two different illuminants. The one or more CICDs and the one or more CEDs combine to form a visible light transmission spectrum of the DFL that specifically controls the color inconstancy of the Color Enhancing DFL to less than 20.0, preferably less than 15.0, more preferably less than 10.0, and even more preferably less than 6.5, in CIELAB color space, when lit separately by two different illuminants, wherein the two different illuminants are selected from the set of four illuminants of (1) CIE D65, (2) CIE F7, (3) CIE F11, and (4) CIE LED-B4. One or more CICDs can be incorporated into and/or onto a DFL using the same method(s) as the one or more CEDs. Two examples CICDs are ABS 455 (having a 459 nm peak absorbance) and ABS 642 (having a 645 nm peak absorbance) from Exciton. A CICD has a concentration of between 0.1 mg to 10.0 g per 1 kg of solvent or plastic material.

For one embodiment of a Color Enhancing DFL that controls color inconstancy, its transmission spectrum 1110b of the DFL is shown in FIG. 11B 1100b. The transmission spectrum 1110b shows the spectral effects of having a CED, ABS 574 1130b, and a CICD, ABS 455 1140b, together dispersed in an RFL comprising a polymer, e.g., an optical with a refractive index of at least 1.58. A different, reference transmission spectrum 1120b comprises the CED, ABS 574 1130b, but does not comprise the CICD, ABS 455 1140b, is constructed for the purpose of comparing color inconstancies under different illuminants. Both transmission spectra 1110b, 1120b comprise the same concentration loading of the CED, ABS 574 1130b. Furthermore:
1. When illuminated separately by CIE D65, the color inconstancy-controlled transmission spectrum 1110b has a white point of L=82.5, a*=4.7 and b*=3.5, and the reference transmission spectrum 1120b has a white point of L=84.2, a*=14.8 and b*=−17.8,
2. When illuminated separately by CIE F11, the color inconstancy-controlled transmission spectrum 1110b has a white point of L=85.6, a*=10.2 and b*=4.6, and the reference transmission spectrum 1120b has a white point of L=87.0, a*=15.7 and b*=−13.6,
3. When illuminated separately by CIE LED-B4, the color inconstancy-controlled transmission spectrum 1110b has a white point of L=80.5, a*=7.5 and b*=3.2, and the reference transmission spectrum 1120b has a white point of L=82.0, a*=17.7 and b*=−23.4,
4. The calculated color inconstancy, using Equation 2, of the color inconstancy-controlled transmission spectrum 1110b (i) is 3.5 when lit separately by CIE D65 and CIE LED-B4, and (ii) is 5.9 when lit separately by CIE F11 and CIE LED-B4,
5. The calculated color inconstancy, using Equation 2, of the reference transmission spectrum 1120b (i) is 6.7 when lit separately by CIE D65 and CIE LED-B4, and (ii) is 11.3 when lit separately by CIE F11 and CIE LED-B4.

In order to reduce optical aberrations in a DFZ when its d-Rx is at steady-state, i.e., d-Rx is not changing, the magnitude of the gauge pressure of an OWF inside a DFL in relation to ambient atmospheric pressure is at least 5.0 pascal (“Pa”), preferably at least 15.0 Pa, more preferably at least 30.0 Pa, and even more preferably at least 45.0 Pa.

A specific example of a construction of a DFL is as follows: the base curve of the DFL is 6.0, with the DFL having a length of 64.0 mm and a height of 41.5 mm, end to end. The total thickness of the DFL at its optical center of distance vision is 2.375 mm. The DFL is comprised of a RFL, an IPS, an SCF, an FOPL with adhesive bonding two parts together. The RFL is a ballistic-strength (i.e., passes ANSI Z87.1 standards) optical-grade polycarbonate lens having a base curve 6, a refractive index of 1.59, and an s-Rx progressive prescription for distance and intermediate vision ground onto or into the outwardly facing optical surface (i.e., outer surface facing the world side, 440b in FIG. 4B). The thickness of the RFL is 1.0 mm at the optical center of distance vision. The RFL's inwardly facing optical surface (i.e., inner surface facing eye side, 450b in FIG. 4B) is domical or substantially domical. An acrylic optical adhesive, 3M 8211 (3M Company, St. Paul, Minnesota), having a thickness of 25 micron and a refractive index of 1.47, is used to bond the inner surface of the perimeter of the RFL to the IPS. The IPS, 320a in FIG. 3A, is a ballistic-strength clear polycarbonate spacer having a base curve 6 and a uniform thickness of 0.5 mm in the direction of the optical axis of the DFL, and a uniform perimeter thickness of 2.0 mm. The adhesive 3M 8211 is used to bond the IPS to the SCF. The SCF is a hardened clear PMMA optical layer having a uniform thickness of 0.75 mm, a base curve 6 and a refractive index of 1.49. The SCF comprise an internal circular void of diameter 19.5 mm 350a in FIG. 3A, located near, or substantially at, the lower inner corner of the DFL, i.e., the void is located towards the nose of a wearer of an Integrated Eyewear comprising the DFL. The SCF is plano or substantially plano. The acrylic optical adhesive 3M 8211 is used to bond the SCF with the FOPL. The FOPL is made of DuPont Melinex 462 (DuPont Teijin Films, Chester, Virginia), a high clarity polyester film with a uniform thickness of 50 micron. The Melinex film has an anti-abrasion coating on the surface exposed to air. A clear, food grade, white mineral oil of mostly aliphatic compounds, with a dynamic viscosity of 8 cP and a refractive index of 1.47 at 25° C., from Phillips 66 Lubricants (Houston, Texas), is used as the OWF. The OWF completely fills, without air bubbles or gap, the DFL. The components of a DFZ in the DFL comprises the FOPL, the adhesive layer, the void in the SCF, the cavity created by the IPS that is optically inside the DFZ, the RFL, and the OWF. Moreover, the DFL comprise at least one opening, e.g., an inlet-outlet hole of diameter 3.5 mm located at, substantially at, or near the top outer corner of the lens, to allow a portion of the OWF to move between the DFL and the at least one connected reservoir, without any fluid leakage. An example opening is a void created in each of the FOPL, the SCF and their intermediate adhesive layer. Another example opening is a void created in the IPS. An example Integrated Eyewear comprises two such DFLs. The OWF RI matches (RI matching) the RFL, the SCF, the optical adhesive and the FOPL.

A specific example of a construction of a reservoir is as follows: a soft, flexible, corrugated and round nitrile bellow of natural (i.e., unloaded) length of 23 mm and inner average diameter of 4 mm is used as a reservoir for the white mineral oil OWF from Phillips 66 Lubricants as described previously. The bellow's minimum contracted longitudinal length is 14 mm and its maximum extended longitudinal length is 29 mm. Only minimal force, less than 0.05 N, is needed to fully contract or extend the bellow longitudinally from its natural length. The nitrile bellow is physically glued to the previously described DFL using an epoxy adhesive, with bellow opening (i.e., mouth) located directly over the DFL's opening, e.g., inlet-outlet hole, to allow movement of a portion of the OWF between the bellow (as reservoir) and the DFL, i.e., reservoir and DFL are fluidically connected. The other end of the nitrile bellow is closed or capped, in order to house the OWF without leakage. The nitrile bellow resides inside the temple of an Integrated Eyewear. The temple only allows the soft and flexible bellow to move in a guided manner, guided by the internal geometry of the temple. The soft and flexible mechanical characteristics of the bellow enable the bellow to bend, commensurate with a hinge (on the frame of the Integrated Eyewear) bending at, substantially at, or near the bellow location. An example Integrated Eyewear comprises two such nitrile bellows—each one connected to each DFL.

A specific example of an integration of an EM-actuator is as follows: a piezoelectric linear actuator, such as model M3-L from New Scale Technologies, Inc. (Victor, New York) with an embedded electronic controller or driver, is used (1) to pull to extend, i.e., increase the volume of, the previously described bellow reservoir in order to move and/or keep a portion of the previously described OWF out of the DFL, which reduces d-Rx in the DFZ, and (2) to push to contract, i.e., decrease the volume of, the reservoir to move and/or keep a portion of the OWF into/inside the DFL, which increases d-Rx in the DFZ. The actuator rod's stroke length is 5.5 mm and the actuator rod is connected to the bellow via a common hook-and-ring setup. When the actuator rod tip is at position-zero, the actuator rod is retracted, which pulls on the bellow in order to draw a portion of the OWF from the DFL into the reservoir. When the rod tip is at position-zero, the DFZ creates a plano, substantially plano, or nearly plano d-Rx. The actuator can maintain position-zero at the rod tip to maintain the indicated d-Rx(s) in the DFZ without (or with minimal) electrical power consumption. When the actuator rod tip is at position-full, the actuator rod is extended, which pushes on the bellow in order to move a portion of the OWF from the reservoir into the DFL. When the rod tip is at position-full, the DFZ creates a 2.5 diopter, uniform d-Rx. The actuator can maintain position-full at the rod tip to maintain the indicated d-Rx(s) in the DFZ without (or with minimal) electrical power consumption. The actuator can be programmed to achieve plano or substantially plano to 2.5 diopter and vice versa within 2.5 seconds of activation. An example Integrated Eyewear comprises two such actuators—each one connected to each bellow inside each frame-temple.

Alternative to an EM-actuator, a specific example of a construction and integration of an MM-actuator is as follows: a plastic actuator rod of length 4 mm is attached to the previously described bellow reservoir and resides inside each frame temple. The plastic actuator rod moves linearly along a slot in the temple and is pushed or pulled manually via a small finger contact pad, connected to the actuator rod, accessible from outside the temple. Friction between the finger pad (i.e., contact pad actuated by a finger) and the slot in the temple allows the actuator rod to move from one position to another position and to maintain any position along the slot. When the rod tip is at position-zero along the slot, the rod pulls on the bellow in order to draw a portion of the OWF from the DFL into the reservoir. When the rod tip is at position-zero, the DFZ creates a plano, substantially plano, or nearly plano d-Rx. The actuator rod can maintain position-zero to maintain the indicated d-Rx(s) in the DFZ via friction with the frame slot. When the actuator rod tip is at position-full, the actuator rod is pushed forward, which pushes on the bellow in order to move a portion of the OWF from the reservoir into the DFL. When the rod tip is at position-full, the DFZ creates a 2.5 diopter, uniform d-Rx. The actuator can maintain position-full to maintain the indicated d-Rx(s) in the DFZ via friction with the frame slot. An example Integrated Eyewear comprises two such actuators—each one connected to each bellow inside each temple.

For the Integrated Eyewear with electromechanical actuation, a specific example of a microcontroller unit (“MCU”) and battery is as follows: a MCU (a type of EC) comprises an Arduino unit that is electrically- and communicatively-connected to two EM-actuators, a tap sensor, an accelerometer and a rechargeable lithium-polymer (“LiPo”) battery. The MCU is on a PCB that resides inside the tip (ear-end) of a temple. The MCU is programmed to command the previously described EM-actuators. The MCU has an on-off switch, and electrically-powers all connected components and/or devices. When the tap sensor registers a finger tap or swipe, then the MCU commands both EM-actuators to each move its rod tip to position-full if the rod tips were previously at position-zero and vice versa. If the “head-tilt” mode is active, then when the head tilts down at least 35 degrees from the horizontal for at least 1.5 seconds as measured by the accelerometer connected to the MCU, then the MCU commands both EM-actuators to each move its rod tip to and/or maintain at position-full to provide a 2.5 diopter optical power in the DFZs, i.e., DFZ activation. When the downward head tilt is less than 35 degrees from the horizontal (e.g., 25 degrees downward tilt) for at least 1.5 seconds, then the MCU commands both EM-actuators to each move its rod tip to and/or maintain at position-zero to provide a plano, substantially plano, or nearly plano d-Rx in the DFZs.

Alternative to an Integrated Eyewear comprising two actuators, a specific example of a one-actuator system to simultaneously actuate two DFLs is as follows: a cable-system comprised of two lines, e.g., two fishing lines, and each line is connected to the rod tip of one actuator on one end and the other end is connected to each of the two bellow reservoirs that is connected to each of the two DFLs. Both lines reside within the frame of an Integrated Eyewear, with one line go through the nose bridge of the frame to connect to the reservoir on the opposite side (e.g., opposite temple) of the actuator. When the one actuator's rod tip is at position-zero, the length of each bellow is at its elastic natural length, which then create a d-Rx of 2.5 diopter in each DFZ located in each DFL. When the one actuator's rod tip retracts 5.5 mm, the rod tip pulls both cable lines and each line pulls on each bellow. Therefore, the rod tip retraction expands the internal volume of both reservoirs to move a portion of the OWFs out of each DFL and into the connected reservoir, to achieve a plano, substantially plano, or nearly plano d-Rx in each DFZ located in each DFL. The cable system is well-lubricated and resides completely within the frame of the Integrated Eyewear.

The Integrated Eyewear is either battery powered or is manual. The total weight of the Integrated Eyewear when worn is less than 80 g, preferably less than 60 g, more preferably less than 50 g, and even more preferably less than 40 g.

The Integrated Eyewear with one or more embedded EM-actuators can operate at least 25 full cycles, preferably at least 50 full cycles, more preferably at least 100 full cycles, even more preferably at least 200 full cycles, and furthermore preferably at least 400 full cycles, on a single full charge of its embedded battery (ies), without the need to recharge. A full cycle means for a normal person with two eyes, the one or more embedded EM-actuators directly or indirectly (1) move a portion of one or more OWFs into at least one DFL for each eye to create at least a 0.65 diopter d-Rx in at least one DFZ located in the at least one DFL for each eye, and (2) move a portion of the one or more OWFs out of the at least one DFL for each eye to create a zero, substantially zero, or nearly zero diopter (i.e., plano, substantially plano, or nearly plano diopter, respectively) d-Rx in the at least one DFZ located in the at least one DFL for each eye.

In one embodiment, the optical device is an eyewear, comprising: a frame, one or more solid elements and one or more liquid elements combine to create one or more DFLs, and the one or more DFLs each comprise one or more DFZs, and one or more FFZs, wherein the percentage ratio of the total optical area of all DFZ(s) in each of the one or more DFLs to the entire optical area of that DFL is less than 65%, preferably less than 50%, and more preferably less than 35%, for all DFL(s). Moreover, the one or more solid elements of the one or more DFLs comprise an RFL, at least one SCF, and at least one FOPL. The at least one FOPL is connected to the at least one SCF.

In the same embodiment, the one or more liquid elements of the one or more DFLs comprise at least one OWF, and the one or more DFZs each comprise the at least one OWF, a cavity created in the at least one SCF, at least one FOPL, and an RFL. Moreover, the optical device comprises one or more of: (1) at least one OIC in the one or more DFLs, (2) at least one NOC in the one or more DFLs, and (3) at least one SCTD. The one or more of at least one OIC, at least one NOC and at least one SCTD (1) transport and comprise the at least one OWF, and (2) connect fluidically to the at least one DFZ. Furthermore, one or more reservoirs, comprising the at least one OWF, fluidically connect to one or more of: (1) at least one OIC through at least one opening in the one or more DFLs, (2) at least one NOC through at least one opening in the one or more DFLs, and (3) at least one SCTD.

In another embodiment, the optical device comprises one or more EM-actuators. The one or more EM-actuators receive operative instructions from one or more ECs embedded in an eyewear or Integrated Eyewear. One or more embedded batteries (i.e., battery (ies) integrated with eyewear) provide electric power to one or more electric components of the Integrated Eyewear comprising the one or more ECs. Moreover, the one or more EM-actuators comprise at least one of (1) and/or (2):
(1) capable of reducing volume of one or more OWFs in one or more reservoirs, capable of moving at least a portion of the one or more OWFs out of the one or more reservoirs and into one or more DFLs, capable of decreasing flexure of at least one FOPL in at least one DFZ towards the world side (equivalently, capable of increasing flexure of at least one FOPL in at least one DFZ towards the eye side), and capable of increasing one or more optical powers in the at least one DFZ, and/or
(2) capable of increasing volume of one or more OWFs in one or more reservoirs, capable of moving at least a portion of the one or more OWFs out of one or more DFLs and into the one or more reservoirs, capable of increasing flexure of at least one FOPL in at least one DFZ towards the world side (equivalently, capable of decreasing flexure of at least one FOPL in at least one DFZ towards the eye side), and capable of decreasing one or more optical powers in the at least one DFZ.

In yet another embodiment, the optical device comprises one or more MM-actuators. The one or more MM-actuators is operated manually. Moreover, the one or more MM-actuators comprise at least one of (1) and/or (2):
(1) capable of reducing volume of one or more OWFs in one or more reservoirs, capable of moving at least a portion of the one or more OWFs out of the one or more reservoirs and into one or more DFLs, capable of decreasing flexure of at least one FOPL in at least one DFZ towards the world side (equivalently, capable of increasing flexure of at least one FOPL in at least one DFZ towards the eye side), and capable of increasing one or more optical powers in the at least one DFZ, and/or
(2) capable of increasing volume of one or more OWFs in one or more reservoirs, capable of moving at least a portion of the one or more OWFs out of one or more DFLs and into the one or more reservoirs, capable of increasing flexure of at least one FOPL in at least one DFZ towards the world side (equivalently, capable of decreasing flexure of at least one FOPL in at least one DFZ towards the eye side), and capable of decreasing one or more optical powers in the at least one DFZ.

In an embodiment of an optical device (i.e., eyewear or Integrated Eyewear), one or more OWFs interface with one or more of:
(1) one or more optical, solid, adhesive materials, and the one or more OWFs and the one or more optical, solid, adhesive materials each maintaining its own acceptable material stability,
(2) one or more SCFs, and the one or more OWFs and the one or more SCFs each maintaining its own acceptable material stability,
(3) one or more FOPLs, and the one or more OWFs and the one or more FOPLs each maintaining its own acceptable material stability, and/or
(4) one or more RFLs, and the one or more OWFs and the one or more RFLs each maintaining its own acceptable material stability.

In an embodiment of an optical device, at least one OWF interfaces with one or more of:
(1) at least one SCF (i.e., SCF feature), and the magnitude of the difference between the average refractive index of the at least one SCF and the average refractive index of the at least one OWF when tested at 25° C. is less than 0.20, preferably less than 0.10, more preferably less than 0.05, even more preferably less than 0.03 and yet more preferably less than 0.02,
(2) at least one FOPL (i.e., FOPL feature), and the magnitude of the difference between the average refractive index of the at least one FOPL and the average refractive index of the at least one OWF when tested at 25° C. is less than 0.30, preferably less than 0.20, more preferably less than 0.10, even more preferably less than 0.05, and further preferably less than 0.03,
(3) an RFL (i.e., RFL feature), and the magnitude of the difference between the average refractive index of an RFL and the average refractive index of the at least one OWF when tested at 25° C. is less than 0.30, preferably less than 0.20, more preferably less than 0.10, even more preferably less than 0.05, and further preferably less than 0.03, and/or
(4) at least one optical, solid, adhesive material, and the magnitude of the difference between the average refractive index of the at least one optical, solid, adhesive material and the average refractive index of the at least one OWF when tested at 25° C. is less than 0.30, preferably less than 0.20, more preferably less than 0.10, even more preferably less than 0.05, and further preferably less than 0.03.

In a preferred embodiment of an optical device, at least one OWF interfaces with one or more of:
(5) at least one SCF (i.e., SCF feature), and the magnitude of the difference between the refractive index of the at least one SCF and the refractive index of the at least one OWF when measured at an incident light wavelength of 550 nm and at 25° C. is less than 0.20, preferably less than 0.10, more preferably less than 0.05, even more preferably less than 0.03 and yet more preferably less than 0.02,
(6) at least one FOPL (i.e., FOPL feature), and the magnitude of the difference between the refractive index of the at least one FOPL and the refractive index of the at least one OWF when measured at an incident light wavelength of 550 nm and at 25° C. is less than 0.30, preferably less than 0.20, more preferably less than 0.10, even more preferably less than 0.05, and further preferably less than 0.03,
(7) an RFL (i.e., RFL feature), and the magnitude of the difference between the refractive index of the at least one RFL and the refractive index of the at least one OWF when measured at an incident light wavelength of 550 nm and at 25° C. is less than 0.30, preferably less than 0.20, more preferably less than 0.10, even more preferably less than 0.05, and further preferably less than 0.03, and/or
(8) at least one optical, solid, adhesive material, and the magnitude of the difference between the refractive index of the at least one optical, solid, adhesive material and the refractive index of the at least one OWF when measured at an incident light wavelength of 550 nm and at 25° C. is less than 0.30, preferably less than 0.20, more preferably less than 0.10, even more preferably less than 0.05, and further preferably less than 0.03.

In one embodiment of an optical device, the optical device comprises at least one EM-actuator, and the at least one EM-actuator is separable from at least one reservoir (equivalently, a reservoir feature of a part comprising the reservoir feature).

In another embodiment of an optical device, the optical device comprises at least one integrated component, wherein the integrated component comprises at least one EM-actuator and at least one reservoir.

In some embodiments, a DFL comprises two or more DFZs, and at least one of the two or more DFZs is fluidically connected to at least one other DFZ in the DFL. Preferably, every DFZ is fluidically connected to at least one other DFZ in the DFL.

In one embodiment, a DFL comprises one or more of: at least one OIC, at least one NOC, and at least one SCTD.

In another embodiment to correct ametropia and/or control myopia progression, the maximum d-Rx is 4.0 diopter, preferably 6.0 diopter, more preferably 8.0 diopter and even more preferably 10.0 diopter, in one or more DFZs in a DFL.

In yet another embodiment, the minimum d-Rx is 1.0 diopter, preferably 0.5 diopter and more preferably 0.2 diopter, in one or more DFZs.

In another embodiment to improve visual performance beyond correcting ametropia and/or controlling myopia progression, the maximum d-Rx is 10.0 diopter, preferably 40.0 diopter and more preferably 80.0 diopter, in one or more DFZs.

In one embodiment, one or more DFLs comprise one of: (1) one or more SCFs and one or more FOPLs are bonded together without using one or more intermediary optical, solid, adhesive materials, (2) one or more SCFs and one or more FOPLs are bonded together using one or more intermediary optical, solid, adhesive materials, or (3) a single component comprises one or more SCF features and one or more FOPL features.

In another embodiment, the dynamic viscosity of an OWF tested at 25° C. is less than 100 centipoise (“cP”), preferably less than 60 cP, more preferably less than 45 cP and even more preferably less than 30 cP.

In yet another embodiment, the average noise level of the loudest actuator in an eyewear or Integrated Eyewear, measured in open air, and measured at a distance of 10.0 mm away from the geometric center of the actuator, with the actuator housed inside a finished frame of the eyewear or Integrated Eyewear, is less than 25.0 dB, preferably less than 10.0 dB, more preferably less than 5.0 dB, even more preferably less than 2.5 dB, and furthermore preferably less than 1.5 dB, during active operation of the actuator.

In one embodiment, the average base curve of the back surface (i.e., inside surface facing eye side) of a DFL, averaged over all the FFZs, ranges between 0.0 and 10.0, preferably between 0.0 and 8.0, more preferably between 0.0 and 7.0, and even more preferably between 3.5 and 7.0, inclusively.

In another embodiment, an SCF comprises an average base curve of between 0.0 and 10.0, preferably between 0.0 and 8.0, more preferably between 0.0 and 7.0, and even more preferably between 3.5 and 7.0, inclusively, averaged over all the FFZs the SCF is an element of.

In one embodiment, for an Integrated Eyewear comprising at least one EM-actuator, the eyewear comprises at least one of: one or more tilt sensors, one or more accelerometers, one or more gyros, one or more touch sensors, one or more microphones, one or more voice-recognition devices, one or more eye-tracking devices, and one or more signal receivers, transmitters and/or transceivers.

In another embodiment, one or more CICDs and the one or more CEDs combine to form a visible light transmission spectrum of a Color Enhancing DFL that specifically controls the color inconstancy of the DFL to less than 15.0, preferably less than 10.0, more preferably less than 7.0, and even more preferably less than 5.5, in CIELAB color space, when lit separately by two different illuminants, wherein the two different illuminants are selected from the set of four illuminants of (1) CIE D65, (2) CIE F7, (3) CIE F11, and (4) CIE LED-B4.

In yet another embodiment, at least one of an RFL and an FOPL of a DFL comprise at least one of: (1) one or more reflective optical coatings, and (2) one or more absorptive dyes, that attenuates the transmission spectrum of the DFL, and its arithmetic average transmission spectrum between 400 nm and 440 nm (inclusive) is at least 5.0% less (absolute) than that between 500 nm and 530 nm (inclusive), with 1 nm resolution.

A non-eyewear optical device comprises at least one of a DFL and a DFZ, and the at least one DFL and the at least one DFZ comprise one or more OWFs. Moreover, the one or more OWFs is, at least in part, capable of being moved by at least one actuator. Examples of the non-eyewear optical device comprise window(s), windshield(s), telescope(s), microscope(s), digital display(s), optical screen(s), optical scope(s), lens(es), optical filter(s), camera(s), reflector(s), optical cover(s), optical housing(s), optical protector(s), bulb(s).

In one embodiment of the non-eyewear optical device, the device comprises one or more of the mechanical, optomechanical, electromechanical, electrical and/or communication elements needed for DFZ activation, DFZ deactivation and/or DFZ OD change.

An optical device comprises one or more optical elements (i.e., optical components) integrated into, applied onto, positioned in front of and/or positioned behind of one of: (1) a DFL, or (2) at least one component of a DFL, e.g., a DFZ, an RFL, a SCL and/or a FOPL, wherein the one or more optical elements show (e.g., transmit, reflect, emit, refract and diffract) one or more of: (1) computer-generated optical content, (2) camera-captured optical content, and/or (3) real world optical content. The one or more optical elements comprise one or more digital display(s), optical screen(s), light-emitting diode(s), projector(s), waveguide(s), splitter(s), lens(es), camera(s), laser(s), diffuser(s), concentrator(s), grating(s), filter(s), prism(s), attenuator(s), polarizer(s), depolarizer(s), waveplate(s), thin film(s), thick film(s), holographic element(s), kinoform(s), reflector(s), diaphragm(s) and/or protector(s).

In one embodiment, a virtual reality device that has an optical component that comprises at least one DFZ.

In another embodiment, an augmented reality device that has an optical component that comprises at least one DFZ.

In one embodiment, a mixed reality device that has an optical component that comprises at least one DFZ.

Although features and elements are described above in particular combinations, one of ordinary skill in the art will appreciate that each feature or element can be used alone or in any combination with or without the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

1. An eyewear, comprising:
an optical device and a frame wherein the optical device comprises:
one or more solid elements and one or more liquid elements combined to create one or more dynamically focusable lenses (“DFLs”), and the one or more DFLs each comprise one or more dynamically focusable zones (“DFZs”) and one or more fixed focus zones (“FFZs”),
wherein the percentage ratio of the total optical area of all DFZ(s) in each of the one or more DFLs to the entire optical area of that DFL is less than 65% for all DFL(s),
the one or more solid elements of the one or more DFLs comprise a rigid front layer (“RFL”), at least one stiffness control feature (“SCF”), and at least one flexible optical power layer (“FOPL”),
the at least one FOPL is physically connected to the at least one SCF,
the one or more liquid elements of the one or more DFLs comprise at least one optical working fluid (“OWF”),
the one or more DFZs each comprises the at least one OWF, one cavity created in the at least one SCF, at least one FOPL, and an RFL,
one or more of: (1) at least one Optical Internal Cavity (“OIC”) in the one or more DFLs, (2) at least one Non-Optical Cavity (“NOC”) in the one or more DFLs, and (3) at least one Separable Conduit to DFZ (“SCTD”), that comprise and transport the at least one OWF,
the one or more of at least one OIC, at least one NOC and at least one SCTD fluidically connect to the at least one DFZ,
one or more reservoirs, comprising the at least one OWF, fluidically connect with one or more of: (1) at least one OIC through at least one opening in the one or more DFLs, (2) at least one NOC through at least one opening in the one or more DFLs, and (3) at least one SCTD;
and wherein the frame comprises at least one electromechanical actuator (“EM-actuator”), wherein the at least one EM-actuator comprises at least one of (1) and (2):
(1) capable of reducing the volume of the one or more OWFs in the one or more reservoirs, capable of moving at least a portion of the one or more OWFs out of the one or more reservoirs and into the one or more DFLs, capable of increasing flexure of the at least one FOPL in the at least one DFZ towards the eye side, and capable of increasing one or more optical powers in the at least one DFZ, and/or
(2) capable of increasing the volume of the one or more OWFs in the one or more reservoirs, capable of moving at least a portion of the one or more OWFs out of the one or more DFLs and into the one or more reservoirs, capable of increasing flexure of the at least one FOPL in the at least one DFZ towards the world side, and capable of decreasing one or more optical powers in the at least one DFZ,
the at least one EM-actuator receive operative instructions from one or more electronic controllers embedded in the frame; and
one or more batteries integrated with the frame provide electric power to one or more electric components of the frame comprising the one or more electronic controllers.

2. The optical device of claim 1, wherein the one or more OWFs interface with one or more optical, solid, adhesive materials, and each material maintains its own acceptable material stability.

3. The optical device of claim 1, wherein the one or more OWFs interface with the one or more SCFs, and each material maintains its own acceptable material stability.

4. The optical device of claim 1, wherein the one or more OWFs interface with the one or more FOPLs, and each material maintains its own acceptable material stability.

5. The optical device of claim 1, wherein the one or more OWFs interface with the one or more RFLs, and each material maintains its own acceptable material stability.

6. The optical device of claim 1, wherein the at least one SCF shares one or more interfaces with the at least one OWF, and the magnitude of the difference between the average refractive index of the at least one SCF and the average refractive index of the at least one OWF is less than 0.20, when tested at 25° C.

7. The optical device of claim 1, wherein the at least one FOPL shares one or more interfaces with the at least one OWF, and the magnitude of the difference between the average refractive index of the at least one FOPL and the average refractive index of the at least one OWF is less than 0.20, when tested at 25° C.

8. The optical device of claim 1, wherein the RFL shares one or more interfaces with at least one OWF, and the magnitude of the difference between the average refractive index of the RFL and the average refractive index of the at least one OWF is less than 0.20, when tested at 25° C.

9. The optical device of claim 1, wherein at least one optical, solid, adhesive materials shares one or more interfaces with at least one OWF, and the magnitude of the difference between the average refractive index of the at least one optical, solid, adhesive materials and the average refractive index of the at least one OWF is less than 0.20, when tested at 25° C.

10. The optical device of claim 1, wherein the at least one electromechanical actuator is separable from the at least one reservoir.

11. The optical device of claim 1, wherein the maximum dynamic add power (“d-Rx”) is 8.0 diopter in the one or more DFZs.

12. The optical device of claim 1, wherein the at least one SCF and the at least one FOPL are bonded together without using one or more intermediary optical, solid, adhesive materials.

13. The optical device of claim 1, wherein the at least one SCF and the at least one FOPL are bonded together using one or more intermediary optical, solid, adhesive materials.

14. The optical device of claim 1, wherein two or more features of a single component comprise (1) at least one SCF feature, and (2) at least one FOPL feature.

15. The optical device of claim 1, wherein the dynamic viscosity of the at least one OWF is less than 100 centipoise, when tested at 25° C.

16. The optical device of claim 1, wherein the average noise level of the loudest EM-actuator is less than 25.0 dB during active operation of the actuator, when measured in open air, at a distance of 10.0 mm away from the geometric center of the actuator, with the actuator housed inside a finished frame of the eyewear.

17. The optical device of claim 1, wherein the average base curve of the DFL's optical surface facing eye side, ranges between 0.0 and 6.5 (inclusive), when measuring the optical surface outside of any DFZ.

18. The optical device of claim 1, wherein the frame comprises at least one of tilt sensor(s), accelerometer(s), gyro(s), touch sensor(s), microphone(s), voice-recognition device(s), eye-tracking device(s), signal receiver(s), signal transmitter(s) and transceiver(s).

19. The optical device of claim 1, wherein one or more Color Inconstancy Control Dyes and one or more Color Enhancing Dyes combine to form the visible light transmission spectrum of the one or more color enhancing DFLs, and to control the color inconstancy of the DFL to less than 15.0 in CIELAB color space, when lit separately by two different illuminants, wherein the two different illuminants are selected from the set of four illuminants of (1) CIE D65, (2) CIE F7, (3) CIE F11, and (4) CIE LED-B4.

20. The optical device of claim 1, wherein one or more optical elements is at least one of integrated into, applied onto, positioned in front of and/or positioned behind of one of: (1) a DFL, or (2) at least one component of a DFL, wherein the one or more optical elements show one or more of: (1) computer-generated optical content, (2) camera-captured optical content, and/or (3) real world optical content.

21. The optical device of claim 20, wherein the one or more optical elements comprise one or more digital display(s), optical screen(s), light-emitting diode(s), projector(s), waveguide(s), splitter(s), lens(es), camera(s), laser(s), diffuser(s), concentrator(s), grating(s), filter(s), prism(s), attenuator(s), polarizer(s), depolarizer(s), waveplate(s), thin film(s), thick film(s), holographic element(s), kinoform(s), reflector(s), diaphragm(s) and/or protector(s).

22. An eyewear, comprising:
an optical device and a frame wherein the optical device comprises:
one or more solid elements and one or more liquid elements combine to create one or more dynamically focusable lenses (“DFLs”), and the one or more DFLs each comprise one or more dynamically focusable zones (“DFZs”) and one or more fixed focus zones (“FFZs”),
wherein the percentage ratio of the total optical area of all DFZ(s) in each of the one or more DFLs to the entire optical area of that DFL is less than 65% for all DFL(s),
the one or more solid elements of the one or more DFLs comprise a rigid front layer (“RFL”), at least one stiffness control feature (“SCF”), and at least one flexible optical power layer (“FOPL”),
the at least one FOPL is physically connected to the at least one SCF,
the one or more liquid elements of the one or more DFLs comprise at least one optical working fluid (“OWF”),
the one or more DFZs each comprises the at least one OWF, one cavity created in the at least one SCF, at least one FOPL, and an RFL,
one or more of: (1) at least one Optical Internal Cavity (“OIC”) in the one or more DFLs, (2) at least one Non-Optical Cavity (“NOC”) in the one or more DFLs, and (3) at least one Separable Conduit to DFZ (“SCTD”), that comprise and transport the at least one OWF,
the one or more of at least one OIC, at least one NOC and at least one SCTD fluidically connect to the at least one DFZ,
one or more reservoirs, comprising the at least one OWF, fluidically connect with one or more of: (1) at least one OIC through at least one opening in the one or more DFLs, (2) at least one NOC through at least one opening in the one or more DFLs, and (3) at least one SCTD;
and wherein the frame comprises at least one manual mechanical actuator, wherein the at least one manual mechanical actuator comprises at least one of (1) and (2):
(1) capable of reducing the volume of the one or more OWFs in the one or more reservoirs, capable of moving at least a portion of the one or more OWFs out of the one or more reservoirs and into the one or more DFLs, capable of increasing flexure of the at least one FOPL in the at least one DFZ towards the eye side, and capable of increasing one or more optical powers in the at least one DFZ, and/or
(2) capable of increasing the volume of the one or more OWFs in the one or more reservoirs, capable of moving at least a portion of the one or more OWFs out of the one or more DFLs and into the one or more reservoirs, capable of increasing flexure of the at least one FOPL in the at least one DFZ towards the world side, and capable of decreasing one or more optical powers in the at least one DFZ.

23. An eyewear, comprising:
an optical device and a frame wherein the optical device comprises:
one or more solid elements and one or more liquid elements combine to create one or more dynamically focusable lenses (“DFLs”), and the one or more DFLs each comprise one or more dynamically focusable zones (“DFZs”) and one or more fixed focus zones (“FFZs”),
wherein the percentage ratio of the total optical area of all DFZ(s) in each of the one or more DFLs to the entire optical area of that DFL is less than 65% for all DFL(s),
the one or more solid elements of the one or more DFLs comprise a rigid front layer (“RFL”) and at least one flexible optical power layer (“FOPL”) feature of a part comprising two or more features,
the at least one FOPL feature is physically connected to at least one stiffness control feature (“SCF”),
the one or more liquid elements of the one or more DFLs comprise at least one optical working fluid (“OWF”),
the one or more DFZs each comprises the at least one OWF, one cavity created in the at least one SCF, at least one FOPL, and an RFL,
one or more of: (1) at least one Optical Internal Cavity (“OIC”) in the one or more DFLs, (2) at least one Non-Optical Cavity (“NOC”) in the one or more DFLs, and (3) at least one Separable Conduit to DFZ (“SCTD”), that comprise and transport the at least one OWF,
the one or more of at least one OIC, at least one NOC and at least one SCTD fluidically connect to the at least one DFZ,
one or more reservoirs, comprising the at least one OWF, fluidically connect with one or more of: (1) at least one OIC through at least one opening in the one or more DFLs, (2) at least one NOC through at least one opening in the one or more DFLs, and (3) at least one SCTD;
and wherein the frame comprises at least one manual mechanical actuator, wherein the at least one manual mechanical actuator comprises at least one of (1) and (2):
(1) capable of reducing the volume of the one or more OWFs in the one or more reservoirs, capable of moving at least a portion of the one or more OWFs out of the one or more reservoirs and into the one or more DFLs, capable of increasing flexure of the at least one FOPL in the at least one DFZ towards the eye side, and capable of increasing one or more optical powers in the at least one DFZ, and/or
(2) capable of increasing the volume of the one or more OWFs in the one or more reservoirs, capable of moving at least a portion of the one or more OWFs out of the one or more DFLs and into the one or more reservoirs, capable of increasing flexure of the at least one FOPL in the at least one DFZ towards the world side, and capable of decreasing one or more optical powers in the at least one DFZ.

24. An eyewear, comprising:
an optical device and a frame wherein the optical device comprises:
one or more solid elements and one or more liquid elements combine to create one or more dynamically focusable lenses (“DFLs”), and the one or more DFLs each comprise one or more dynamically focusable zones (“DFZs”) and one or more fixed focus zones (“FFZs”),
wherein the percentage ratio of the total optical area of all DFZ(s) in each of the one or more DFLs to the entire optical area of that DFL is less than 65% for all DFL(s),
the one or more solid elements of the one or more DFLs comprise a rigid front layer (“RFL”) and at least one flexible optical power layer (“FOPL”), wherein the thickness of the at least one FOPL is nonuniform,
the one or more liquid elements of the one or more DFLs comprise at least one optical working fluid (“OWF”),
the one or more DFZs each comprises the at least one OWF, one cavity created in the at least one SCF, at least one FOPL, and an RFL,
one or more of: (1) at least one Optical Internal Cavity (“OIC”) in the one or more DFLs, (2) at least one Non-Optical Cavity (“NOC”) in the one or more DFLs, and (3) at least one Separable Conduit to DFZ (“SCTD”), that comprise and transport the at least one OWF,
the one or more of at least one OIC, at least one NOC and at least one SCTD fluidically connect to the at least one DFZ,
one or more reservoirs, comprising the at least one OWF, fluidically connect with one or more of: (1) at least one OIC through at least one opening in the one or more DFLs, (2) at least one NOC through at least one opening in the one or more DFLs, and (3) at least one SCTD;
and wherein the frame comprises at least one actuator, wherein the at least one actuator comprises at least one of (1) and (2):
(3) capable of reducing the volume of the one or more OWFs in the one or more reservoirs, capable of moving at least a portion of the one or more OWFs out of the one or more reservoirs and into the one or more DFLs, capable of increasing flexure of the at least one FOPL in the at least one DFZ towards the eye side, and capable of increasing one or more optical powers in the at least one DFZ, and/or
(4) capable of increasing the volume of the one or more OWFs in the one or more reservoirs, capable of moving at least a portion of the one or more OWFs out of the one or more DFLs and into the one or more reservoirs, capable of increasing flexure of the at least one FOPL in the at least one DFZ towards the world side, and capable of decreasing one or more optical powers in the at least one DFZ.
